(19) United States
(12) Patent Application Publication
(10) Pub. No.: US 2026/0325275 A1
(43) Pub. Date: Oct. 22, 2026

(54) HEALING BODY SYSTEM

(71) Applicant: VARIABLE HEALING ABUTMENT S.R.O., Praha (CZ)

(72) Inventor: Alexander SCHILL, Bratislava - Karlova Ves (SK)

(73) Assignee: VARIABLE HEALING ABUTMENT S.R.O., Praha (CZ)

(21) Appl. No.: 19/109,600

(22) PCT Filed: Sep. 30, 2023
(86) PCT No.: PCT/CZ2023/050063

§ 371 Date: Mar. 7, 2025

(30) Foreign Application Priority Data
Oct. 10, 2022 (CZ) PV 2022-428

(51) Int. Cl. A61C 13/08; A61C 8/00; A61C 13/107

(52) U.S. Cl. CPC A61C 13/082; A61C 8/0001; A61C 8/0054; A61C 8/0056; A61C 13/0001

(57) ABSTRACT

A healing body system based on a healing body assembly includes a base of the healing body and a gingival extension, which is put on a coronal portion of the base from outside by an apical section of its through cavity while fitting their anti-rotation elements and coaxially connecting their through cavities into a common through cavity, into which a basal screw for fixing the assembly in an implant and a healing body plug for fixing the gingival extension in the base are inserted. Furthermore, the system includes an impression pin and a scanning body for analog and digital imprinting, and screws for their fixation, a control pin for controlling the position of the implant and an implant plug. The system solves all aspects associated with a dental implant, both the shaping of bone tissue during healing of the implant and the shaping of soft tissue during its subsequent adjustment.

### TECHNICAL FIELD

The invention relates to a healing body system intended for creation of high aesthetics of soft gingival tissues after introduction of dental implants, which serves to shape soft tissues above the dental implant to an optimal state for the design, function and aesthetics of future prosthetics a for maintaining the lifetime of dental implants. Thus, the invention relates to the field of dental industry, especially implantology.

### PRIOR ART

Dental implants for anchoring one or several artificial teeth have been known for several decades. Currently, there are many hundreds of types of dental implants on the market, which differ from one another.

The currently existing means intended for shaping the soft tissues above the implant are usually referred to as so-called healing rollers or healing abutments. They are always inserted into an introduced dental implant and have the function of a body that is surrounded (overgrown) by soft tissue during the healing process.

U.S. Pat. No. 6,129,548 A discloses a two-piece healing abutment comprising a body and a screw for attaching the body to a dental implant.

US 2011/200 967 A1 discloses a dental healing abutment assembly having a tubular holder and a plurality of removable nestable shells having a pass-through hole for accommodating a mounting member for securing to the dental implant.

US 2011/244 425 A1 discloses universal dental healing abutments having circumferential body attachable to a dental implant, a tapered lower section and a central through opening for attaching to the implant using a screw, and kits comprising at least one universal healing abutment, at least one screw, and at least one crown.

U.S. Pat. No. 5,106,300 A discloses a dental implant attachment system comprising an abutment member, securing means, and an impression cap.

WO 2018/172261 A1 discloses a two-part modelling aid for connection to a dental implant component, comprising a coronal end, an apical end, and a through bore extending from the apical end to the coronal end, and, at its apical end, first anti-rotation means for cooperation with the dental implant, and, at its coronal end, second anti-rotation means for cooperation with the anti-rotation section of a base part of the modelling aid.

The development of the healing body system according to the invention was initiated by the lack of such an assortment of aids on the market that would meet a number of criteria in one. The currently existing means are unsatisfactory for several reasons:
they are not applicable to any arbitrary implant system, e.g. they are produced by the manufacturer of the implantology system and are only compatible with this particular type of implant;
their design is easy to manufacture, but inappropriate in shape, they are too simplified in shape and thus, they may not provide a correct result from an aesthetic and health point of view, the healed soft tissues and prosthetics shaped according to them do not consequently have a natural and correct design;
or they are shaped correctly from an aesthetic (anatomical) point of view, but they solve only a limited number of cases, they do not have the necessary range of parts in terms of sizes, or they are not compatible for all types of fixtures from the given manufacturer;
they are not ready for imprinting by both analog and digital way at the same time. In most cases, the soft tissues shaped by the healing abutments are imprinted analogically using impression materials. In order to imprint the situation, it is necessary to remove the healing abutment before the impression, and as a result, the soft tissue starts to change during the impression and its shape is deformed. This results in a significant inaccuracy in the impression, which is subsequently copied into the plaster laboratory model and into the shape of the prosthetics. The correct conditions for soft tissue are often overlooked, and thus not only the aesthetics of the result is affected, but also the durability of the modelled soft tissue, which tends to recede when overloaded. The situation of inaccuracies of the analog impression is partly solved by some healing abutment systems, which envisage only a digital impression and have the shape of the abutment already predefined in digital libraries, which are subsequently used in designing the precise prosthetics. They, however, cannot solve the analog impression using impression material, which is sometimes necessary;
the use of current aids as a basis for an individually made healing body, which can be manually finally modeled by a doctor during surgery, is laborious, time-consuming and technologically complex.

The healing body system should bring new possibilities of shaping soft tissues above the position of bone-level and tissue-level dental implants to the work process of the dentist-implantologist, simplifying and speeding up the work, and thus also reducing the burden on the patient. It solves all aspects, both bone tissue shaping during implant healing and soft tissue shaping during its subsequent adjustment.

### Subject-Matter of the Invention

The above-mentioned disadvantages of the prior art are solved by the healing body system according to the invention.

In a first aspect, the present invention provides a gingival extension of a healing body for shaping soft tissue above an implant, the gingival extension comprising a body with a through cavity extending in the coronal-apical direction, the external shape of which imitates, at least in the part to be in contact with the soft tissue, the shape of the transition neck of the dental crown, wherein
an annular apical abutment surface directed apically is arranged at the apical end on the outer surface of the gingival extension;
the through cavity of the gingival extension comprises
   an apical section comprising, at its apical end, along a part of its circumference, an apical anti-rotation recess directed radially outwards, and at its coronal end, along a part of its circumference, a coronal anti-rotation recess directed radially outwards;
   optionally a coronal section which is coaxial with the apical section and which is wider than the apical section in cross-section at least along a part of its circumference;
a coronal abutment surface directed coronally is formed at the transition between the inner surface of the apical section of the through cavity of the gingival extension and
   the outer surface of the coronal end of the gingival extension, or
   the inner surface of the coronal section of the through cavity of the gingival extension.

In another aspect, the present invention provides a base of a healing body for attachment to an implant, the base comprising a body with a through cavity extending in a coronal-apical direction and having an annulus on the outer surface with an annular axial abutment surface directed coronally, which divides the base into an apical portion for attachment to the implant and a coronal portion, wherein the through cavity has a larger cross-sectional diameter at the coronal end than at the apical end, and the inner surface of the through cavity transitions in the apical portion of the base from the cross-sectional diameter at the coronal end to the cross-sectional diameter at the apical end by a transition section, wherein
the coronal portion has a tubular shape and has a plane coronal abutment surface at its coronal end;
at least one identification relief directed radially inwards is arranged on the outer circumference of the coronal end of the coronal portion;
an anti-rotation projection directed radially outwards is formed on the outer circumference of the apical end of the coronal portion;
the through cavity is provided with a coronal internal thread at the coronal end of the coronal portion.

In another aspect, the present invention provides a healing body assembly comprising
the base of the healing body as defined above;
the gingival extension as defined above,
   wherein the apical section of the through cavity of the gingival extension is put on the coronal portion of the base from outside so that the apical abutment surface of the gingival extension abuts against the axial abutment surface of the base, the anti-rotation projection of the base fits into the apical anti-rotation recess of the gingival extension, and the through cavities of the gingival extension and the base are coaxially connected to form a common through cavity of the healing body assembly;
a basal screw which is inserted into the common through cavity of the healing body assembly for fixing the healing body assembly in an implant by means of an external thread at the apical end of the shank of the basal screw so that the bearing surface of the head of the basal screw rests on the transition section of the through cavity of the base and the head of the basal screw does not interfere into the space of the coronal internal thread at the coronal end of the coronal portion of the through cavity of the base; and
a healing body plug, which is inserted into the common through cavity of the healing body assembly for fixing the gingival extension in the base so that the external thread at the apical end of the shank of the plug is screwed into the coronal internal thread of the base so that the head of the plug rests on the coronal abutment surface of the gingival extension.

In case of treatment (healing) of a dental implant without immediate loading, an implant plug is used, which prevents future bone tissue from growing in an inappropriate way and prepares the shape of the bone tissue around the implant so that the subsequent application of the healing body system is problem-free and does not require additional modifications (removal) of the overlapping bone by grinding away. The implant plug is one-piece, rotationally symmetrical and has the shape of a screw with a head and a shank, which has an external thread at least at its apical end for attachment to the implant, preferably a thread with a size ranging from M1.4 to M2.0, more preferably M1.4, M1.6, M1.8, or M2.0. The shape of the implant plug in the apical portion of the head is adapted to the specific type of implant and is preferably screwed into it with a system screwdriver. The implant plug is preferably made of metal, more preferably a titanium alloy, most preferably Ti6Al4V titanium alloy. Depending on the level of immersion of the implant below the bone level, the dentist chooses an implant plug around which the bone will grow and a clean opening above the level of the implant is created for the insertion of the base of the healing body. The coronal height of the head of the implant plug preferably ranges from 0 mm to 4 mm, more preferably it is 1 mm, 2 mm, or 3 mm. The external diameter of the head of the implant plug in the coronal portion preferably ranges from 2.9 mm to 8 mm, more preferably it is 2.9 mm, 3.3 mm, 4.1 mm, or 4.5 mm.

The base of the healing body is the basic supporting component of the healing body, which is placed onto an implant and secured in it by a basal screw (see below), which passes through this component (the shape of the base is similar to the “interface” type components, commonly used in implantology). The base may preferably be made from anyone of the group of suitable materials including plastics, ceramics and metals, such as, for example, polyether ether ketone (PEEK), polyether ketone ketone, reinforced polymers, for example reinforced with glass fibers, carbon fibers and/or ceramic particles, dental hybrid ceramics, glass ceramics, lithium-disilicate ceramics, alloys of cobalt and chromium, zirconium dioxide and aluminum oxide, more preferably from titanium or a titanium alloy, most preferably Ti6Al4V titanium alloy. In the apical portion, the base has a shape that enables a perfect connection with the abutting (and sealing) profile of the implant, including fitting of anti-rotational elements (the shape and dimensions of the apical portion change depending on the type and size of the implant on which it will be placed). In the apical portion, the shape and dimensions of the base are derived from the shape and dimensions of the attached implant, and thus there are different size and type variants of the bases for different types of implants and their size series. The base always has a definite position relative to the implant, fixed by anti-rotation elements that are present on both the implant and the base, and thus it cannot rotate relative to the implant after connecting and screwing in the basal screw. The cross-section of the coronal portion of the base can preferably have a circumference in the shape of a circle, oval or ellipse, more preferably a circle. Preferably, the annular axial abutment surface is perpendicular to the longitudinal axis of the base, and more preferably it extends outwards immediately from the outer surface of the base. The circumference of the annular axial abutment surface can preferably have the shape of a circle, oval or ellipse, more preferably a circle. Preferably, the surface of the transition section of the through cavity of the base has the shape of the surface of a truncated cone. The through cavity of the base is preferably provided, apically from the transition section, with an apical internal thread, preferably a thread with a size in the range from M1.4 to M2.0, more preferably of M1.4, M1.6, M1.8, or M2.0, for screwing through the basal screw and other screws of the system according to the invention, e.g. the screw of the impression pin (see below), so that they cannot spontaneously fall out of the base during handling. A coronal internal thread, preferably a thread with a size ranging from M2.0 to M3.5, preferably of M2.5 or M3.0, serves for fastening the supported components. The coronal portion of the base is universal for a certain series of the healing body system, any gingival extension of this series can be placed on any base of this series. The number of identification reliefs is preferably 2-4, preferably 2 or 3, most preferably 3. The identification reliefs are preferably distributed along the circumference of the coronal end in such a way that each type of the base (and thus implant) enables the fixation of a single type of scanning body. For example, in case of three identification reliefs in such a way that the axis of the first relief forms a first angle, the axis of the second relief forms a second angle and the axis of the third relief forms a third angle, in each case with the axis of the anti-rotation projection, whereas the first angle is preferably 0° to 350°, for example 73°, the second angle is preferably 5° to 355°, for example 143°, 153°, 163°, or 173°, and the third angle is preferably 10° to 360°, for example 287°. The axes of the individual reliefs preferably form an angle of at least 5° with one another, more preferably at least 70°. In case of small bases (e.g. for SC implants from the company Straumann Holding AG, Basel, CH) with a coronal portion of an oval or elliptical shape, two identification reliefs are preferable, distributed along the circumference of the coronal end in such a way that the axis of the first relief forms a first angle and the axis of the second relief forms a second angle, with the axis of the anti-rotation projection, whereas the first angle is preferably −45° to +45°, more preferably 0°, and the second angle is preferably 135° to 225°, for example 175°, 180° or 185°. Preferably, the outer side of said at least one identification relief lies on an imaginary circle with the external diameter of the coronal portion of the base (or on the corresponding imaginary oval or ellipse). On the side facing away from the circumference of the coronal portion of the base, the identification relief and the anti-rotation projection can have any suitable cross-sectional shape, for example the shape of a broken or curved line, but they preferably have a rounded shape, most preferably the shape of a circular arc. The base for each type and dimension of the implant has several versions of the height of the apical portion, preferably at least 2, respecting the different depth of immersion of the implant with respect to the level of the bone border. The total height of the base is preferably in the range from 4 to 15 mm, more preferably 6.35, 7.35, 8.1, or 9.1 mm. The coronal portion of the base preferably has a height in the range from 2 to 9 mm, more preferably 2.1 mm, and preferably has an external diameter, or the largest external cross-sectional dimension, in the range from 2.0 to 4.5 mm, more preferably 2.1, 3.3, 4.0, or 4.5 mm. The annular axial abutment surface preferably has the largest external dimension in the range from 2.9 to 9 mm, more preferably it has a circular shape with an external diameter of 4.1 mm.

The task of the gingival extension is to shape the soft tissue above the implant. It may preferably be made from anyone of the group of suitable materials including plastics, ceramics and metals, such as, for example, polyether ether ketone, polyether ketone ketone, reinforced polymers, for example reinforced with glass fibers, carbon fibers and/or ceramic particles, dental hybrid ceramics, glass ceramics, lithium disilicate ceramics, cobalt and chromium alloys, zirconium dioxide and aluminum oxide, more preferably from titanium and titanium alloys, most preferably Ti6Al4V titanium alloy. It can be put on any base within one series of the healing body system. The through cavity of the gingival extension can preferably be circular, oval or elliptical, more preferably circular. The through cavity of the gingival extension is preferably thread-free and the internal dimension of the through cavity in its apical section is such that the apical section can be put on the coronal portion of the base, so it preferably corresponds to the external shape and size of the coronal portion of the base, more preferably it has dimensions in a cross-section perpendicular to the longitudinal axis of the gingival extension in the range from 2.02 mm to 4.52 mm, most preferably 2.12 mm, 3.32 mm, 4.02 mm, or 4.52 mm. The coronal section of the through cavity of the gingival extension can preferably have a circular, oval or elliptical internal shape and always such that a plug of the healing body can be inserted into the coronal section, so it preferably corresponds to the external diameter of the head of the plug of the healing body, most preferably it has dimensions in a cross-section perpendicular to the longitudinal axis of the gingival extension in the range from 3.1 mm to 5.5 mm, preferably a diameter of 3.12 mm, 3.32 mm, 4.02 mm, 4.52 mm or 5.22 mm, most preferably a diameter of 3.32 mm. On the side facing away from the through cavity of the gingival extension, the anti-rotation recesses can have any suitable cross-sectional shape, for example the shape of a broken or curved line, but they preferably have a rounded shape, most preferably the shape of a circular arc. Individual types of the gingival extension differ in construction height due to the thickness of the soft tissue at the implant site. The choice of the height of the gingival extension is related to the chosen height of the base of the healing body, and the combination of both components is decided by the dentist. The total height of the gingival extension is preferably in the range from 2.5 mm to 10.0 mm, more preferably 2.5 mm, 3.5 mm, 5.0 mm or 7.0 mm, while the height of the apical section is preferably in the range from 2.08 mm to 2.5 mm, more preferably 2.08 mm or 2.48 mm. The gingival extension has a definite position relative to the base, and thus also relative to the implant, determined by the anti-rotation projection of the base and the apical anti-rotation recess of the gingival extension shape-complementary thereto. This is necessary due to the asymmetrical shape of the gingival extension, which is always designed for a specific position of the implant within the jaw arch, and only the correct rotational position of the gingival extension in the vestibulo-oral direction will ensure the desired shape and aesthetics of the healed soft tissue. Accordingly, the future application of the healing body system has to be taken into account already during the implantation of the dental implant, and the correct rotation position of the implant, and thus subsequently of the entire future assembly of the healing body, has to be always ensured. This is achieved during implantation (screwing the implant into the bone) by using a control device—a control pin (see below) with a gingival extension put thereon, thanks to which very precise positioning of the implant can be achieved. There is a variety of gingival extensions (shapes and sizes thereof) to fulfill their function in a specific place in the jaw and for different heights of soft tissue. The top plan shape of the gingival extensions is derived from the top plan shape of the respective tooth, while the gingival extension at the coronal end, preferably up to a distance of 2 mm, respects this shape and then the gingival extension gradually narrows to the shape and size, preferably the diameter, of the base annulus. Thus, the gingival extension has an external dimension at the apical end preferably in the range from 2.9 mm to 9 mm, more preferably it has a circular shape with a diameter of 4.1 mm.

The basal screw is intended for securing the base of the healing body into the implant, it is similar to the system screw for each type of implant and is preferably tightened by a system screwdriver. It is preferably made of metal, more preferably a titanium alloy, most preferably Ti6Al4V titanium alloy, and its external thread preferably has a size in the range from M1.4 to M2.0, more preferably M1.4, M1.6, M1.8, or M2.0. Its height is preferably in the range from 5.0 mm to 15.0 mm, more preferably 6.7 mm, 7.0 mm or 8 mm, the external diameter of its head at the coronal end has a diameter in the range from 1.9 mm to 2.5 mm, preferably 2.1 mm, 2.2 mm or 2.4 mm.

The healing body plug is a screw-like component that has two functions-it draws the gingival extension to the base of the healing body and at the same time closes the internal opening of the gingival extension in the coronal-apical direction from the occlusal side against the penetration of dirt into the internal space of the implant/base/gingival extension/plug assembly. It is a universal component for all assemblies of a given series of the healing body assembly, preferably for several series. By screwing the plug into the coronal internal thread of the base, a fixed connection of the set-implant/base of the healing body/gingival extension, as a functional assembly of components, is created. The plug of the implant body is preferably made of metal, more preferably a titanium alloy, most preferably Ti6Al4V titanium alloy, its external thread preferably has a size in the range from M2.0 to M3.5, more preferably M2.5 and M3.0, and is preferably screwed by a system screwdriver. Its height is preferably in the range from 2.0 mm to 13 mm, more preferably 2.0 mm or 3.0 mm, the external diameter of its head is preferably in the range from 3.0 mm to 5.5 mm, more preferably 3.0 mm, 3.2 mm, 3.9 mm, 4.4 mm or 5.1 mm, most preferably 3.9 mm.

In another aspect, the present invention provides an impression pin having the shape of a hollow cylindrical body with a through cavity extending in the coronal-apical direction and having a larger cross-sectional diameter at the coronal end than at the apical end, wherein the inner surface of the through cavity transitions from the cross-sectional diameter at the coronal end to the cross-sectional diameter at the apical end by a transition section, wherein fixing means for fixing the impression material are arranged on the outer surface of the cylindrical body at the coronal end, and a threaded section having an external thread and a smaller external diameter than the cylindrical body is formed at the apical end, while at the transition of the outer surface between the threaded section and the cylindrical body, a coronal bearing surface directed apically is formed.

In another aspect, the present invention provides an impression pin assembly comprising
the base of the healing body as defined above;
the gingival extension as defined above,
   wherein the apical section of the through cavity of the gingival extension is put on the coronal portion of the base from outside so that the apical abutment surface of the gingival extension abuts against the axial abutment surface of the base, the anti-rotation projection of the base fits into the apical anti-rotation recess of the gingival extension, and the through cavities of the gingival extension and the base are coaxially connected to form a common through cavity of the healing body assembly;
the impression pin as defined above;
   wherein the apical end of the impression pin is inserted into the common through cavity of the healing body assembly so that the threaded section of the impression pin is screwed into the coronal internal thread of the base, the coronal abutment surface of the impression pin abuts against the coronal abutment surface of the gingival extension and the through cavities of the impression pin, the gingival extension and the base are coaxially connected to form a common through cavity of the impression pin assembly;
an impression pin screw, which is inserted into the common through cavity of the impression pin assembly for fixing the impression pin assembly in the implant by means of an external thread at the apical end of the shank of the impression pin screw so that the bearing surface of the head of the impression pin screw rests on the transition section of the through cavity of the impression pin.

The impression pin is a universal component within one series of the implant body system, which is intended for transferring the position of the implant to the impression when using the analog impression method using an impression material. It can be preferably made from anyone of the group of suitable materials including plastics and metals, such as thermoplastic polymers, polyether ether ketone, polyether ketone ketone, reinforced polymers, for example reinforced with glass fibers, carbon fibers and/or ceramic particles, cobalt and chromium alloys, zirconium dioxide, austenitic stainless steels, aluminum alloys with one or more elements such as copper, magnesium, silicon, nickel, zinc, manganese or titanium, and aluminum oxide, more preferably titanium or a titanium alloy, most preferably Ti6Al4V titanium alloy. For impression using the open method, it is provided at the coronal end with fixation means for good fixation in the impression material, preferably by ribbing or grooving. Preferably, the fixing means are formed by consecutive protrusions and grooves in a direction perpendicular to the longitudinal axis of the impression pin, with grooves and surfaces arranged parallel to this axis. The apical end is intended for inserting into the through cavity of the gingival extension and screwing into the coronal internal thread of the base. The external thread of the threaded section has a size ranging from M2.0 to M3.5, preferably M2.5 or M3.0. In a preferable embodiment, the cylindrical body does not have the same external diameter throughout its entire extension and can be narrower in the section starting at a distance from the threaded section and extending in the coronal direction so that a widened section having a larger external diameter than the cylindrical body of the impression pin is formed coronally from the threaded section at the apical end of the impression pin. More preferably, an intermediate section having a smaller external diameter than the widened section and a larger external diameter than the threaded section is arranged at the apical end of the impression pin between the widened section and the threaded section, so that the coronal abutment surface is formed at the transition of the outer surface between the intermediate section and the widened section and an apical bearing surface directed apically is formed at the transition of the outer surface between the intermediate section and the threaded section, which faces against the coronal abutment surface of the base in the impression pin assembly, after the screw of the impression pin is screwed in. The largest external diameter of the cylindrical body at the apical end of the impression pin, or the external diameter of the widened section, is such that the apical end of the impression pin can be inserted into the coronal section of the through cavity of the gingival extension, preferably having an external diameter in the range from 3.0 mm to 5.5 mm, more preferably an external diameter of 3.0 mm, 3.2 mm, 3.9 mm, 4.4 mm, or 5.1 mm, most preferably a diameter of 3.9 mm. The external diameter of the intermediate section is such that it can be inserted into the apical section of the through cavity of the gingival extension, preferably in the range from 2.0 mm to 4.5 mm, more preferably 2.1 mm, 3.3 mm, 4.0 mm, or 4.5 mm. The total height of the impression pin is preferably in the range from 8.0 mm to 25.0 mm, more preferably 14.6 mm. The impression pin is hollow and the impression pin screw can be inserted into its cavity to secure the base/gingival extension/impression pin assembly into the implant. The internal cross-sectional diameter of the through cavity coronally from the transition section is preferably in the range from 1.9 mm to 3 mm, preferably 2.2 mm, 2.3 mm, or 2.6 mm. The impression pin screw is different depending on the type of implant and is preferably tightened with a system screwdriver. It is preferably made of metal, more preferably a titanium alloy, most preferably Ti6Al4V titanium alloy. It preferably has an external metric thread in the range from M1.4 to M2.0, more preferably M1.4, M1.6, M1.8, or M2.0, the external diameter of its head coronally from its bearing surface is preferably in the range from 1.9 mm to 2.5 mm, more preferably 2.1 mm, 2.2 mm, or 2.4 mm, and its height is preferably in the range from 20.0 mm to 35.0 mm, more preferably 26 mm. When using the impression pin, the entire assembly is left in the impression to record the precise shape of soft tissues when casting the plaster model. After the impression is made, an identical combination of components-base/gingival extension, which the dentist left in the impression, is inserted into the implant.

In another aspect, the present invention provides a control pin for controlling the position of an implant, the control pin comprising an annulus on the outer surface with an annular axial abutment surface directed coronally, which divides the control pin into an apical portion for attachment to the implant and a coronal portion, which has a cylindrical shape, an anti-rotation projection directed radially outwards is arranged on the outer circumference at its apical end and a control element is arranged at its coronal end.

In another aspect, the present invention provides a control pin assembly comprising
the control pin as defined above; and
the gingival extension as defined above,
   wherein the apical section of the through cavity of the gingival extension is put on the coronal portion of the control pin from outside so that the apical abutment surface of the gingival extension abuts against the axial abutment surface of the control pin and the anti-rotation projection of the control pin fits into the apical anti-rotation recess of the gingival extension.

The control pin is a component needed for the correct positioning of the implant during its implantation. The gingival extension has to be in a precise position in the jaw in order to fulfill its function, and therefore it is necessary to maintain its correct position already during implantation-screwing the implant. This can be achieved approximately according to the marks, which are usually present on the original transfer components of the implants, but more precise positioning can be achieved by the control pin. The dentist puts the selected gingival extension (corresponding to the position of the implant relative to the jaw) onto the control pin and inserts the control pin into the implant fixture. Now they can check the current rotation position of the implant, or gingival extension, respectively. If they decide to subsequently change the position of the implant, they place a control tool, preferably a ratchet or a suitable tightening wrench, on the control element of the control pin, preferably polygonal, more preferably triangular to octagonal, even more preferably hexa-to octagonal, most preferably octagonal, and turns the implant to the desired position. The control pin may be made of anyone of the group of suitable materials including metals such as cobalt and chromium alloys, austenitic stainless steels, aluminum alloys with one or more elements such as copper, magnesium, silicon, nickel, zinc, manganese or titanium, more preferably from titanium or a titanium alloy, most preferably Ti6Al4V titanium alloy. In the apical portion, it has a shape adapted to the implant, analogously to the apical portion of the base, as described above. The coronal portion of the control pin can preferably have a cross-section in the shape of a circle, oval or ellipse, more preferably a circle. The control pin always has a definite position relative to the implant, fixed by the anti-rotation elements that are present both on the implant and the control pin, and thus it cannot rotate relative to the implant. The anti-rotation projection is analogous to the anti-rotation projection of the base and shape-complementary to the apical anti-rotation recess of the gingival extension. On the side facing away from the circumference of the coronal portion of the control pin, the anti-rotation projection can have any suitable cross-sectional shape, for example the shape of a broken or curved line, but it preferably has a rounded shape, most preferably the shape of a circular arc. The annular axial abutment surface preferably is perpendicular to the longitudinal axis of the control pin, and more preferably it extends outwards immediately from the outer surface of the control pin. The circumference of the annular axial abutment surface can preferably have the shape of a circle, oval or ellipse, more preferably a circle. The external shape and dimensions of the coronal portion are such that it is possible to put the gingival extension thereon, preferably its external dimension, or external diameter, corresponds to the internal dimension, or the internal diameter, of the apical section of the through-cavity of the gingival extension, at least in the apical section of the coronal portion, which should be in the apical section of the through cavity of the gingival extension after insertion thereof, more preferably it is in the range from 2.0 mm to 4.5 mm, most preferably 2.1 mm, 3.3 mm, 4.0 mm, or 4.5 mm. The height of the control pin is preferably in the range from 8.0 mm to 35.0 mm, more preferably 16.0 mm or 17.3 mm. The annular axial abutment surface preferably has the largest external dimension in the range from 2.9 to 9 mm, more preferably it has a circular shape with an external diameter of 4.1 mm.

In another aspect, the present invention provides a scanning body comprising a body and a head, which is arranged at the coronal end of the body so that the body and the head together have the shape of a hollow cylindrical body with a through cavity extending in the coronal-apical direction, on the inner surface of which an inner bearing surface is formed, whereas a scanning recess is formed on the outer surface at the coronal end of the head, and an anti-rotation projection directed radially outwards and an apical abutment surface directed apically, from which at least one identification protrusion protrudes in the apical direction, are arranged at the apical end of the body.

In another aspect, the present invention provides a scanning body assembly comprising
the base of the healing body as defined above;
the gingival extension as defined above,
   wherein the apical section of the through cavity of the gingival extension is put on the coronal portion of the base from outside so that the apical abutment surface of the gingival extension abuts against the axial abutment surface of the base, the anti-rotation projection of the base fits into the apical anti-rotation recess of the gingival extension, and the through cavities of the gingival extension and the base are coaxially connected to form a common through cavity of the healing body assembly;
a basal screw which is inserted into the common through cavity of the healing body assembly for fixing the healing body assembly in an implant by means of an external thread at the apical end of the shank of the basal screw so that the bearing surface of the head of the basal screw rests on the transition section of the through cavity of the base and the head of the basal screw does not interfere into the space of the coronal internal thread at the coronal end of the coronal portion of the through cavity of the base;
the scanning body as defined above,
   wherein the apical end of the scanning body is inserted into the common through cavity of the healing body assembly so that the anti-rotation projection fits into the coronal anti-rotation recess of the gingival extension, the apical abutment surface abuts against the coronal abutment surface of the base, said at least one identification protrusion fits into said at least one identification relief of the base and the through cavities of the scanning body, the gingival extension and the base are coaxially connected to form a common through cavity of the scanning body assembly; and
a scanning body screw, which is inserted into the common through cavity of the scanning body assembly for fixing the scanning body and the gingival extension in the base so that the external thread at the apical end of the shank of the scanning body screw is screwed into the coronal internal thread of the base so that the bearing surface of the head of the scanning body screw rests on the inner bearing surface of the scanning body.

The scanning body is a component that is intended for digital imprinting of the implant position. It can be made as a one-piece, entirely from one type of material, which is listed below for the body or head, but preferably it is made as a two-piece from a combination of two materials, i.e. the body from one material and the head from another material. Its body, which is inserted into the opening in the gingival extension where it fits into the reliefs at the coronal end of the base of the healing body, is preferably made, due to durability and accuracy of function, from anyone of the group of suitable materials including metals such as, for example, cobalt and chromium alloys, zirconium dioxide, austenitic stainless steels, aluminum alloys with one or more elements such as copper, magnesium, silicon, nickel, zinc, manganese or titanium, preferably titanium or a titanium alloy, most preferably Ti6Al4V titanium alloy. Its head is preferably made, for problem-free scanning using intra-oral scanner (IOS), from anyone of the group of suitable materials including plastics, such as thermoplastic polymers, polyether ether ketone, polyether ketone ketone, reinforced polymers, reinforced with glass fibers, carbon fibers and/or ceramic particles, more preferably from polyether ether ketone. The scanning body has a cross-sectional circumference in the shape of a circle, oval or ellipse, more preferably a circle. The scanning recess, preferably a bevel in the shape of a circular segment, allows the scanner to identify the position and rotation of the scanning body. The head is preferably pressed or glued to the body. The coronal end of the body in the part to which the head is attached preferably has a smaller external diameter than the part of the body continuing apically from the head, while even more preferably there is a recess on the outer surface of the coronal end of the metal part corresponding to the scanning recess, which serves as an anti-rotation element to properly connect the two parts. The head preferably has an external diameter ranging from 2.5 mm to 6.0 mm, more preferably 2.9 mm or 4.5 mm. The total height of the scanning body is preferably such that the head protrudes from the through cavity of the gingival extension, more preferably in the range from 5 to 25 mm, most preferably 10.53 mm. In one preferable embodiment, the cylinder of the body is wider in cross-section apically from the head in the coronal part at least along a part of the outer circumference (i.e. in case of a circular cross-section it has a larger external diameter) than at the apical end of the body so that an apical narrowed section is formed at the apical end of the body and a coronal abutment surface is formed at the transition of the outer surface between the apical narrowed section and the rest of the body, which, after fixing the scanning body, faces against the coronal abutment surface of the gingival extension. In this embodiment of the scanning body with an oval or elliptical cross-section, the widening is preferably formed on two opposite sides of the shorter axis of symmetry of the oval (or the minor axis of the ellipse), in case of a circular cross-section of the body, the widening is preferably formed throughout the entire circumference and the coronal abutment surface is interrupted by an anti-rotation projection reaching in the radial direction to the level of the outer surface of the body with the larger external diameter. The outer side of said at least one identification protrusion facing radially outwards and the inner side of the anti-rotation projection facing radially into the through cavity of the scanning body preferably lie on an imaginary circle having the external diameter of the body of the scanning body (or on the corresponding imaginary oval or ellipse), or in the above mentioned preferable embodiment having the diameter of the apical narrowed section (or on the corresponding imaginary oval or ellipse). The inner side of said at least one identification protrusion and the outer side of the anti-rotation projection of the scanning body can have any suitable cross-sectional shape, for example the shape of a broken or curved line, but preferably a rounded shape, most preferably the shape of a circular arc. The number and distribution of the identification protrusions of the scanning body are defined analogously to the definition of the identification reliefs of the base. In one preferred embodiment, the anti-rotation projection extends beyond the apical abutment surface in the apical direction by a shorter distance than said at least one identification protrusion. A screw of the scanning body can be inserted into the through-cavity of the scanning body, by which the scanning body is tightly secured into the coronal internal thread of the base. The screw of the scanning body is preferably tightened with a system screwdriver. The screw is preferably made of metal, more preferably a titanium alloy, most preferably Ti6Al4V titanium alloy. Its external thread preferably has a size in the range from M2.0 to M3.5, more preferably M2.5 or M3.0. The inner bearing surface for abutment of the head of the scanning body screw is preferably formed in the coronal part of the through cavity of the scanning body, while it can also be formed by the surface of the coronal end of the body. The inner bearing surface is preferably formed in such a way that the through cavity of the scanning body is narrowed apically from the inner bearing surface, or widened coronally from the inner bearing surface, and the inner bearing surface is formed at the transition of the inner surface of the through cavity between the narrower and wider section. The inner bearing surface preferably extends from the inner wall of the through cavity coronally from it and diagonally or perpendicularly to it. The through cavity of the scanning body is preferably provided with an internal thread apically from the inner bearing surface, preferably a thread with a size in the range from M2.0 to M3.5, more preferably M2.5 and M3.0, for screwing through the scanning body screw so that it cannot spontaneously fall out of the scanning body during handling. As already described above, the base of the healing body and the scanning body have a unique identification and fixation combination of the lock from the identification reliefs, and identification projections, respectively, so that a single scanning body corresponds to each type of base. The identification protrusions of the scanning body are shape-complementary to the identification reliefs of the base, and the anti-rotation projection of the scanning body is shape-complementary to the coronal anti-rotation recess of the gingival extension, while the distribution (and number) of the identification protrusions and the anti-rotation projection along the circumference of the apical end of the scanning body corresponds to the distribution (and number) of the identification reliefs and the anti-rotational projection along the circumference of the coronal end of the base as described above. Thanks to this connection, the scanning body, in addition to its main function, i.e. precise scanning of the implant position, also serves as an identifier of the used base. This unique feature can be used during scanning in such a way that the dentist does not have to disassemble all the components above the implant and visually detect their types, but simply unscrews the healing body plug and inserts the expected type of scanning body into the cavity. If it fits into the lock, which defines its correct position, it is possible to secure it subsequently with the screw inside the body. If the type of scanning body was not chosen correctly, the body cannot be put into the correct position and cannot be secured with the screw, in the preferable circular embodiment it also rotates in the gingival extension. This way, the dentist recognizes the wrong choice and chooses another scanning body from the narrow set they have ready for the procedure. By this identification process, it is possible to determine both the type of base used and, essentially, the type of implant, which excludes a mistake of the dentist when identifying the implants or bases used.

In another aspect, the present invention provides a kit comprising
at least one of the following components:
   the gingival extension as defined above;
   the base of the healing body as defined above;
   the impression pin as defined above;
   the control pin as defined above;
   the scanning body as defined above;
and optionally at least one of the following means:
   an implant plug for shaping bone tissue around the implant, the implant plug having the shape of a screw with a head and a shank, which has an external thread at its apical end for attachment to the implant;
   a basal screw for insertion into the common through cavity formed by the through cavities of the gingival extension and the base for fixing the gingival extension and the base in the implant by means of an external thread at the apical end of the shank of the basal screw so that the bearing surface of the head of the basal screw rests on the transition section of the through cavity of the base and the head of the basal screw does not interfere into the space of the coronal internal thread at the coronal end of the coronal portion of the through cavity of the base; and
   a healing body plug for insertion into the common through cavity formed by the through cavities of the assembly of the gingival extension and the base for fixing the gingival extension in the base so that the external thread at the apical end of the shank of the plug is screwed into the coronal internal thread of the base so that the head of the plug rests on the coronal abutment surface of the gingival extension;
   an impression pin screw for insertion into the common through cavity formed by the through cavities of the impression pin, the gingival extension and the base for fixing the assembly of the impression pin, the gingival extension and the base in the implant by means of an external thread at the apical end of the shank of the impression pin screw so that the bearing surface of the head of the impression pin screw rests on the transition section of the through cavity of the impression pin;
   a scanning body screw for insertion into the common through cavity formed by the through cavities of the scanning body, the gingival extension and the base for fixing the scanning body and the gingival extension in the base so that the external thread at the apical end of the shank of the scanning body screw is screwed into the coronal internal thread of the base so that the bearing surface of the head of the scanning body screw rests on the inner bearing surface of the scanning body.

Preferable kits according to the present invention contain various combinations of the above-mentioned components and means, optionally handling aids for handling them and optionally tightening tools, such as a screwdriver, a ratchet, or a wrench. It is obvious for one skilled in the art that individual components, means, aids and tools will also be offered individually by pieces, also in larger packages, and by assemblies. Preferable kits will contain complete series of the system according to the invention for the given implantology systems.

The heads of all the above-mentioned screw components, i.e. screws and plugs, can be provided with knurling along the circumference. They can be provided with any element for a tightening tool, preferably a screwdriver, preferably with a simple slot, a cross slot (e.g. Phillips, Pozidriv, etc.), a specialized slot (e.g. Tri-Wing, Torq-Set, Spanner head), a cavity in the form of an internal polygon (e.g. square (Robertson), hexagon), cavity in the form of a multi-pointed star (e.g. Torx six-pointed star), specialized cavity (e.g. Unigrip type), preferably hexagonal cavities of sizes 0.9 mm, 1.0 mm, 1.20 mm, 1.25 mm, 1.4 mm, Unigrip or Torx sockets. One skilled in the art understands that most advantageously the heads of all screws of the system for a particular implant will be provided with a system element for a tightening tool. The shanks of all the above-mentioned screw components, i.e. screws and plugs, can be provided with a thread along the entire extension course of the shank, preferably at least in the vicinity of the apical end of the shank, most preferably at least at the apical end of the stem.

All anti-rotation elements of the system according to the present invention are preferably arranged one above the other. In oval or elliptical embodiments, the anti-rotation elements are preferably arranged at the top of the longer axis of symmetry of the oval, or the major axis of the ellipse.

The materials from which the above-mentioned components of the system according to the invention are made are preferably biologically compatible.

As used herein, the term “apical” means toward the root of the tooth. As used herein, the term “coronal” means toward the crown of the tooth.

As used herein, the term “cross-section” means a cross-section perpendicular to the longitudinal axis, i.e. the axis extending in the coronal-apical direction, of the given component or a part thereof.

One skilled in the art will understand that in case that a shape of a particular component, element, portion or section is mentioned herein, e.g., cylindrical, circular, oval, elliptical, etc., the said component, element, portion or section is formed substantially in said shape, i.e., deviations from said shape are included, such as a widening, narrowing, projection, recess, relief or protrusion in a part of said shape. One skilled in the art will also understand that for parts that are inserted into each other, there has to be a clearance between the outer wall of the inner part to be inserted and the inner wall of the outer part, that is, although this clearance is expressed herein by larger dimensions of the outer part by 0.02 mm, in fact also reasonable deviations from the mentioned dimensions are included.

As used herein, the term “system” (screw, screwdriver, element, etc.) means a component (aid, shape) that is directly supplied (constructed) by the manufacturer of a specific dental implant and fits into or is compatible with a specific implant system.

As used herein, the term “implant” means a dental implant of the hollow screw type, screwed into the bone tissue in the patient's upper or lower jaw.

As used herein, the term “universal” in connection with the individual components of the system according to the present invention means that the given component is universal within one particular embodiment of the system series, that is, an embodiment where the dimensions of the respective cooperating parts of the components correspond to each other.

The healing body system is applicable to bone-level and tissue-level dental implants and all their dimensional versions. It follows from this that there have to be several shape and size series of the healing body system, which contain functionally identical types of individual components, but these components cannot be combined with each other between individual series due to different sizes and shapes of transition and connecting elements. For one type of implant in its several dimensional variants, a common series of the healing body system can be preferably defined in such a way that some components in the series are unique for each size of the implant, while the others can be preferably common (these components are then considered universal in the given series of the system).

The healing body system according to the invention is an innovative system of coherent components that guarantees simpler, faster and error-free work of the dentist. It is universally developed and thus applicable to any implant system. It is developed for easy use when taking the patient's impressions by any method-both analog (using impression materials) and digital (using an intra-oral scanner).

The healing body system according to the invention provides a number of advantages:
It is a complex system comprising everything a dentist needs for an effective result-both the functional components and the necessary aids for applying the individual components in the right way.

It is insofar variable that it allows application to almost all used types and sizes of dental implants.
It covers commonly used implantation techniques.
It provides the dentist with the option of choosing variable elements, when different types of bases of the healing body can be combined for one type of implant and then different variants of gingival extensions can be placed on them, while the connection between the base and the gingival extension is universal and the healing body plug is also universal.
It is designed to eliminate possible user error during the digital impression process using IOS, which in consequence makes the dentist's work faster and more efficient.
The base and the scanning bodies have a unique identification and fixing lock combination, so that a single scanning body corresponds to each type of the base. This excludes the mistake of the dentist when identifying the implants or the bases used.
In addition to a legible marking with a catalog code, each component can also be provided with a matrix/QR code that is legible for an intra-oral scanning camera. Thus, the dentist takes a scan of the scanning body (records the position of the implant), the gingival extension and the surrounding soft tissue around the gingival extension at once during a digital impression, and thus, all the necessary information on the types of components used (implant fixture, base and gingival extension) automatically records.
It is ready for both types of imprinting, both analog and digital, namely so that the shape of the soft tissue around the body is always fully and accurately recorded and no deviations occur.
Thanks to the universal parts, it is possible to advantageously use the system simultaneously also for a combination of implantology systems and save treatment costs.

The invention will be further described by means of exemplary embodiments with reference to the figures in the drawings. It will be obvious to one skilled in the art that many changes, modifications, variations or adaptations may be made to the invention as described herein without departing from the scope of the invention as defined in the claims. In particular, it should be noted that the components cooperating with the implant will always be adapted to the given implant, and therefore these parts are shown in the drawings only as an illustrative example.

### BRIEF DESCRIPTION OF THE DRAWINGS

FIG. 1 shows the implant plug with three different heights.

FIGS. 2A to 2E show a first embodiment of the base according to the invention in different views:

FIG. 2A a bottom view;

FIG. 2B a front view;

FIG. 2C a sectional view along line A-A from FIG. 2B;

FIG. 2D a top view;

FIG. 2E a perspective view from above, front and left.

FIG. 2F shows a perspective view from above, front and left of the second variant of the first embodiment of the base according to the invention having a higher height of the apical portion.

FIG. 2.1A to 2.1F show a second embodiment of the base according to the invention in different views:

FIG. 2.1A a bottom view;

FIG. 2.1B a front view;

FIG. 2.1C a sectional view along line A-A from FIG. 2.1B;

FIG. 2.1D a top view;

FIG. 2.1E a perspective view from above, front and left;

FIG. 2.1F a perspective view from above, behind and left.

FIGS. 3A and 3B show an embodiment of the basal screw in different views:

FIG. 3A a top view;

FIG. 3B a front view.

FIGS. 4A to 4E show a first embodiment of the gingival extension according to the invention in different views:

FIG. 4A a bottom view;

FIG. 4B a front view;

FIG. 4C a sectional view along line B-B from FIG. 4B;

FIG. 4D a top view;

FIG. 4E a perspective view from below, behind and right.

FIG. 4F shows other variants of the first embodiment of the gingival extension according to the invention with different heights in a front, side and perspective view from above, behind and right.

FIG. 4.1A to 4.1F show a second embodiment of the gingival extension according to the invention in different views:

FIG. 4.1A a bottom view;

FIG. 4.1B a front view;

FIG. 4.1C a sectional view along line A-A from FIG. 4B;

FIG. 4.1D a top view;

FIG. 4.1E a perspective view from below, front and left.

FIG. 4.1F a perspective view from above, front and left.

FIGS. 5A to 5C show a first embodiment of the healing body plug according to the invention in different views:

FIG. 5A a front view;

FIG. 5B a top view;

FIG. 5C a perspective view from below.

FIG. 5.1 shows a perspective view from below of a second embodiment of the healing body plug according to the invention.

FIG. 6 shows a first embodiment of the healing body assembly according to the invention in a front view and in a sectional view along line A-A from the front view (with an implant analog for illustration).

FIG. 6.1A and 6.1B show a second embodiment of the healing body assembly according to the invention (without an implant analog) in different views:

FIG. 6.1A a front view and a sectional view along line A-A from the front view;

FIG. 6.1B a left side view and a sectional view along line B-B from the left side view.

FIGS. 7A to 7C show a first embodiment of the impression pin according to the invention in different views:

FIG. 7A a front view;

FIG. 7B a sectional view along line B-B from FIG. 7A;

FIG. 7C a top view.

FIGS. 7D to 7H show a preferable variant of the first embodiment of the impression pin according to the invention in different views:

FIG. 7D a front view;

FIG. 7E a sectional view along line A-A from FIG. 7D;

FIG. 7F a top view;

FIG. 7G a perspective view from below, front and right;

FIG. 7H perspective view from above, front and left.

FIG. 7.1A to 7.1D show a second embodiment of the impression pin according to the invention in different views:

FIG. 7.1A a bottom view;

FIG. 7.1B a front view;

FIG. 7.1C a sectional view along line A-A from FIG. 7.1B;

FIG. 7.1D a top view.

FIG. 8 shows a first embodiment of the impression pin assembly according to the invention in a front view and in a sectional view along line A-A from the front view (with an implant analog for illustration).

FIG. 8.1A and 8.1B show a second embodiment of the impression pin assembly according to the invention (without an implant analog) in different views:

FIG. 8.1A a front view and a sectional view along line A-A from the front view;

FIG. 8.1B a left side view and a sectional view along line B-B from the left side view.

FIGS. 9A to 9D show a first embodiment of the control pin according to the invention in different views:

FIG. 9A a side view;

FIG. 9B a slightly rotated front view;

FIG. 9C a perspective view from below, behind and left;

FIG. 9D a perspective view from above, behind and left.

FIG. 9.1A to 9.1D show a second embodiment of the control pin according to the invention in different views:

FIG. 9.1A a side view;

FIG. 9.1B a rear view;

FIG. 9.1C a perspective view from above, front and left;

FIG. 9.1D a perspective view from below, front and left.

FIG. 10 shows a first embodiment of the control pin assembly according to the invention in a front view and in a sectional view along line B-B from the front view.

FIGS. 11A to 11G show a first embodiment of the scanning body according to the invention in different views:

FIG. 11A a rear view;

FIG. 11B a sectional view along line A-A from FIG. 11A;

FIG. 11C a side view;

FIG. 11D a bottom view;

FIG. 11E a perspective view from above, front and left;

FIG. 11F a perspective view from below, behind and left;

FIG. 11G a perspective view from above, behind and right.

FIGS. 11H to 110 show a preferable variant of the first embodiment of the scanning body according to the invention in different views:

FIG. 11H a side view;

FIG. 11I a sectional view along line A-A from FIG. 11H;

FIG. 11J an exploded side view;

FIG. 11K a bottom view;

FIG. 11L a top view;

FIG. 11M a perspective view from below, front and left;

FIG. 11N a perspective view from below, behind and left;

FIG. 11O a perspective view from above, front and left.

FIG. 11P shows a bottom view of a first embodiment of the scanning body according to the invention with three exemplary distributions of the identification protrusions and the anti-rotation projection.

FIG. 11.1A to 11.1G show a second embodiment of the scanning body according to the invention in different views:

FIG. 11.1A a front view;

FIG. 11.1B a sectional view along line A-A from FIG. 11.1A;

FIG. 11.1C a bottom view;

FIG. 11.1D a top view;

FIG. 11.1E a perspective view from above, front and right;

FIG. 11.1F a perspective view from below, front and right;

FIG. 11.1G a perspective view from above, front and left.

FIG. 11.1H shows a bottom view of a second embodiment of the scanning body according to the invention with three exemplary distributions of the identification protrusions and the anti-rotation projection.

FIG. 12 shows a first embodiment of the scanning body assembly according to the invention in a front view and in a sectional view along line A-A from the front view (with an implant analog for illustration).

FIG. 12.1 shows a second embodiment of the scanning body assembly according to the invention in a front view and in a sectional view along line A-A from the front view (without an implant analog).

### EXAMPLES OF EMBODIMENTS OF THE INVENTION

### Implant Plug

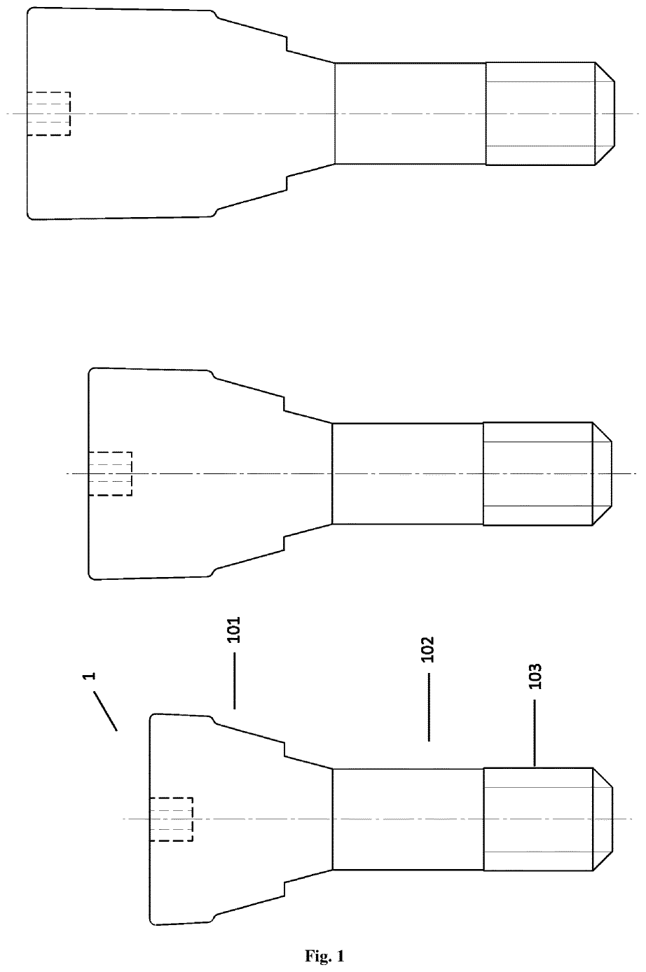

FIG. 1 shows the implant plug 1 in three different heights, which itself is not an object of the invention, but can be a part of a kit according to the invention. The implant plug 1 has the shape of a screw with a head 101 and a shank 102, which has an external thread 103 at its apical end for attachment to the implant.

### Healing Body Base

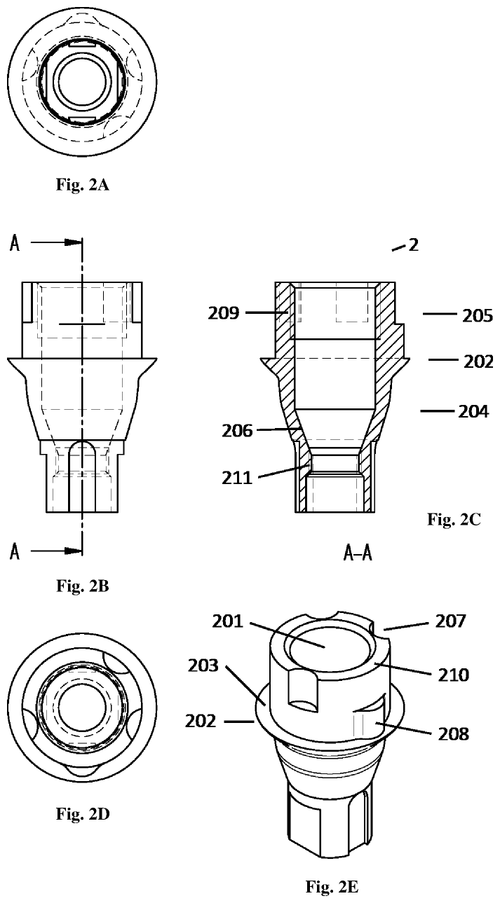

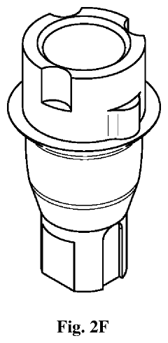

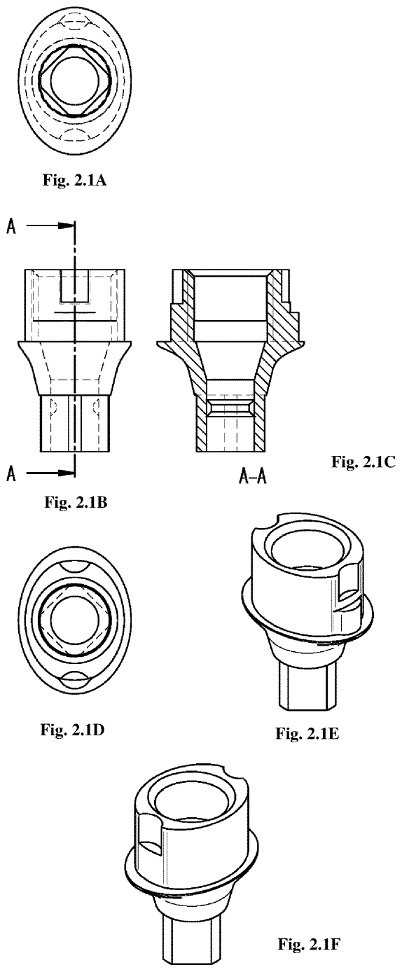

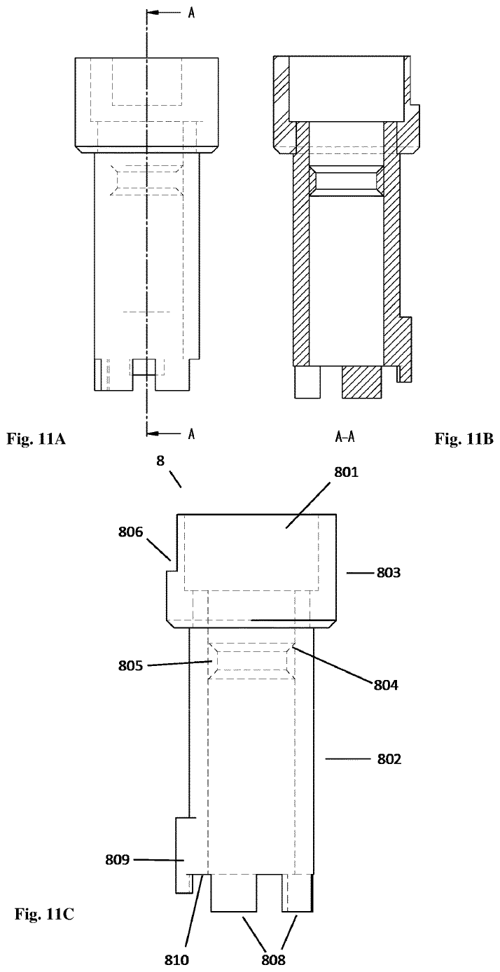

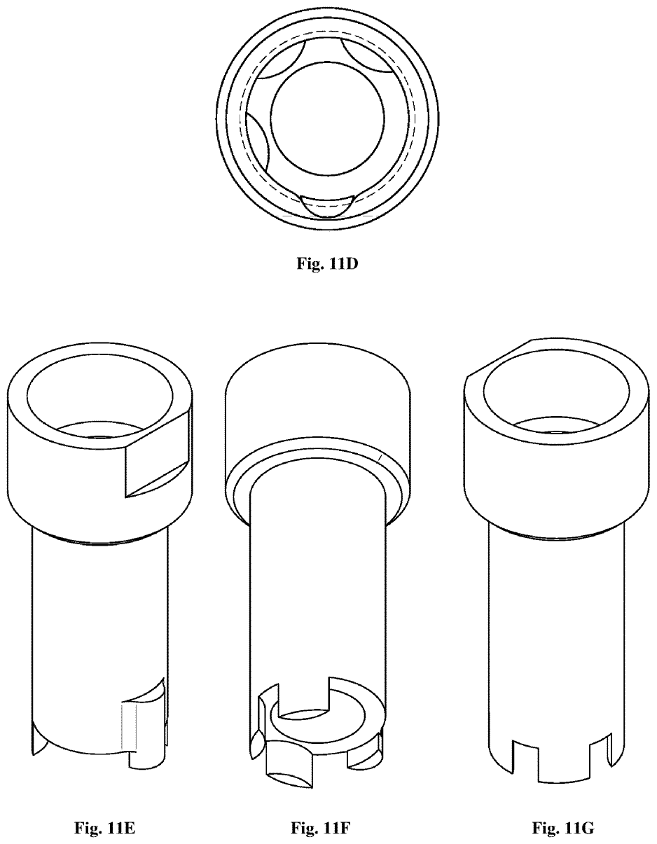

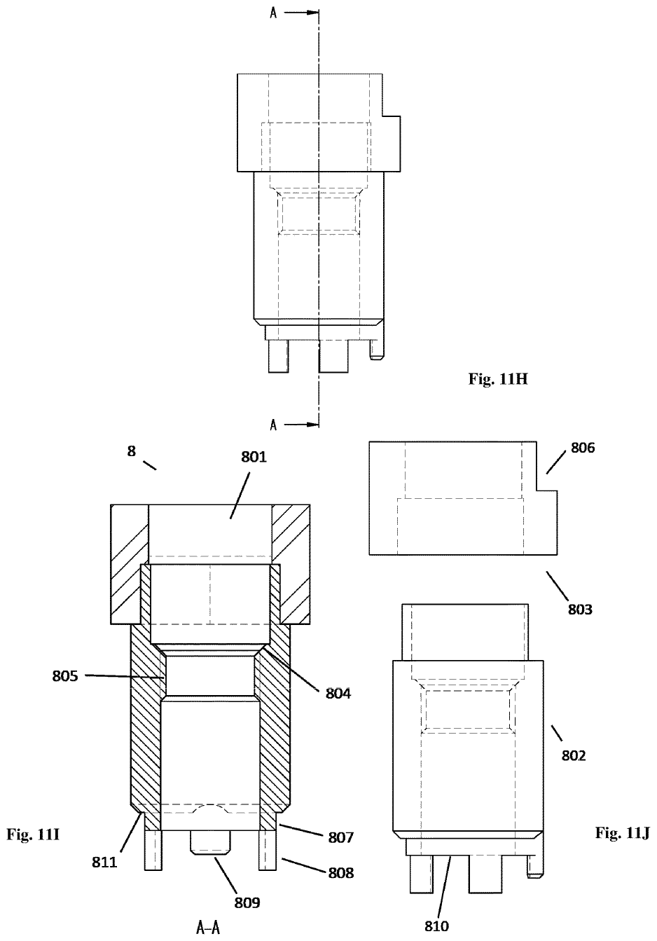

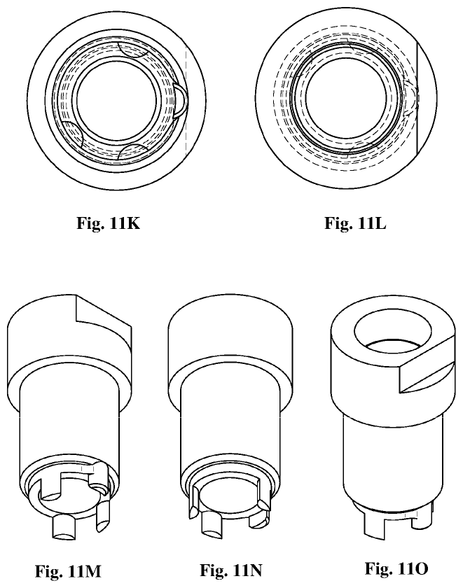

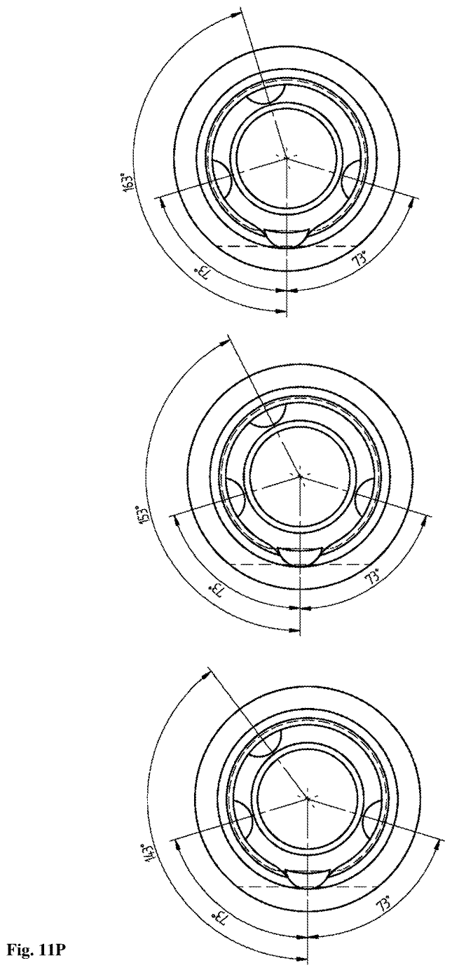

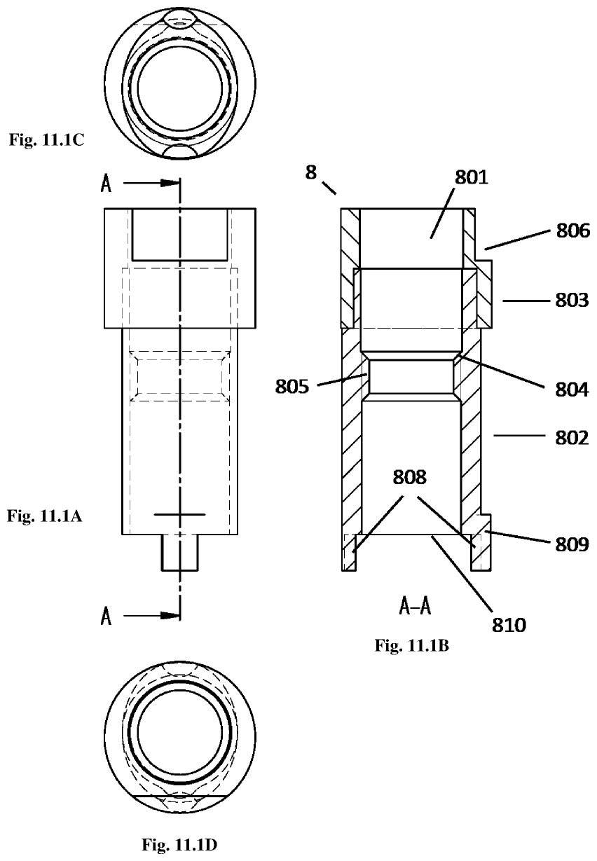

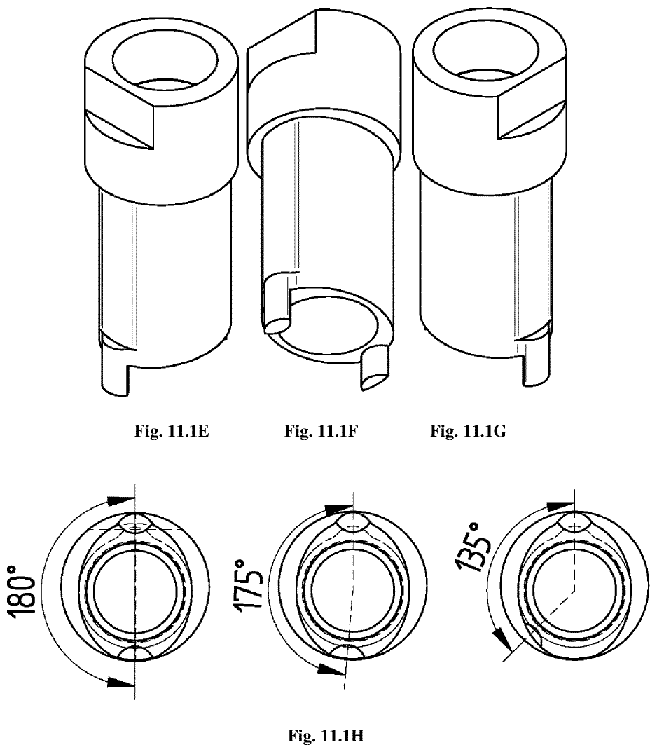

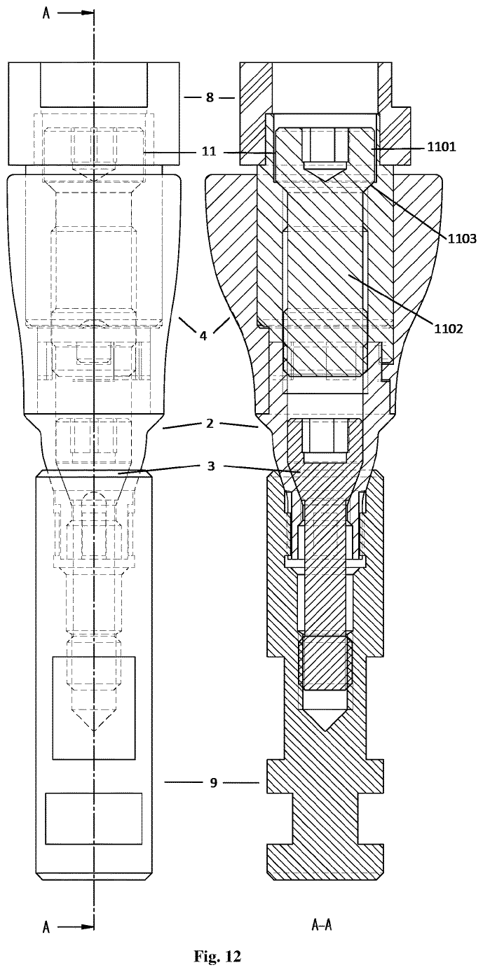

FIGS. 2A to 2E show a first embodiment of a base 2 according to the invention, which comprises a body with a through cavity 201 extending in a coronal-apical direction and having an annulus 202 on the outer surface with an annular axial abutment surface 203 directed coronally, which has a circumference in the shape of a circle and which divides the base 2 to an apical portion 204 for attachment to the implant, which has a circumference in the shape of a circle in cross-section, and a coronal portion 205. The through cavity 201 has a larger cross-sectional diameter at the coronal end than at the apical end, and the inner surface of the through cavity transitions in the apical portion 204 of the base 2 from the cross-sectional diameter at the coronal end to the cross-sectional diameter at the apical end by a transition section 206. The coronal portion 205 has a tubular shape and has a plane coronal abutment surface 210 at its coronal end. Three identification reliefs 207 directed radially inwards are arranged on the outer circumference of the coronal end of the coronal portion 205, and an anti-rotation projection 208 directed radially outwards is formed on the outer circumference of the apical end of the coronal portion 205. Exemplary distributions of the identification reliefs and the anti-rotation projection correspond to the exemplary distributions of the identification protrusions and the anti-rotation projection of the first embodiment of the scanning body according to the invention in FIG. 11P. The through cavity 201 is provided with a coronal internal thread 209 at the coronal end of the coronal portion 205 and it is provided with a preferable apical internal thread 211 apically from the transition section 206 for screwing through the basal screw and other screws of the system according to the invention.

FIG. 2F shows a second variant of the first embodiment of the base 2 according to the invention having a higher height of the apical portion.

FIG. 2.1A to 2.1F show a second embodiment of the base 2 according to the invention, differing from the above mentioned first embodiment according to FIGS. 2A to 2E in particular in that the surface 203 and the coronal portion 205 are oval. Furthermore, two identification reliefs 207 are arranged on the outer circumference of the coronal end of the coronal portion 205 in the second embodiment. Exemplary distributions of the identification reliefs and the anti-rotation projection correspond to the exemplary distributions of the identification protrusions and the anti-rotation projection of the second embodiment of the scanning body according to the invention in FIG. 11.1H.

### Basal Screw

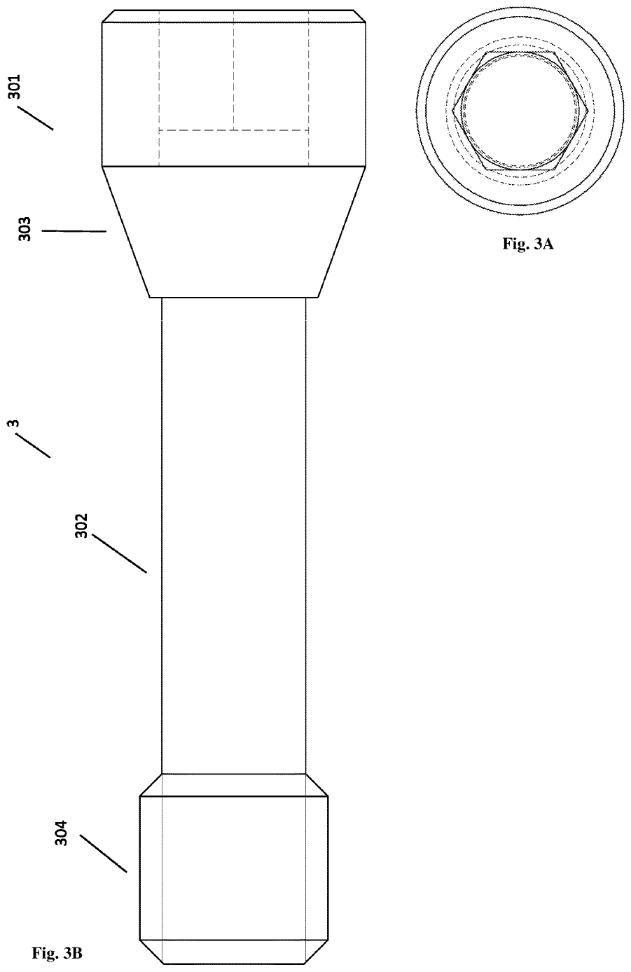

FIGS. 3A and 3B show a basal screw 3 comprising a head 301 with a bearing surface 303 and a shank 302 with an external thread 304 at the apical end.

### Gingival Extension

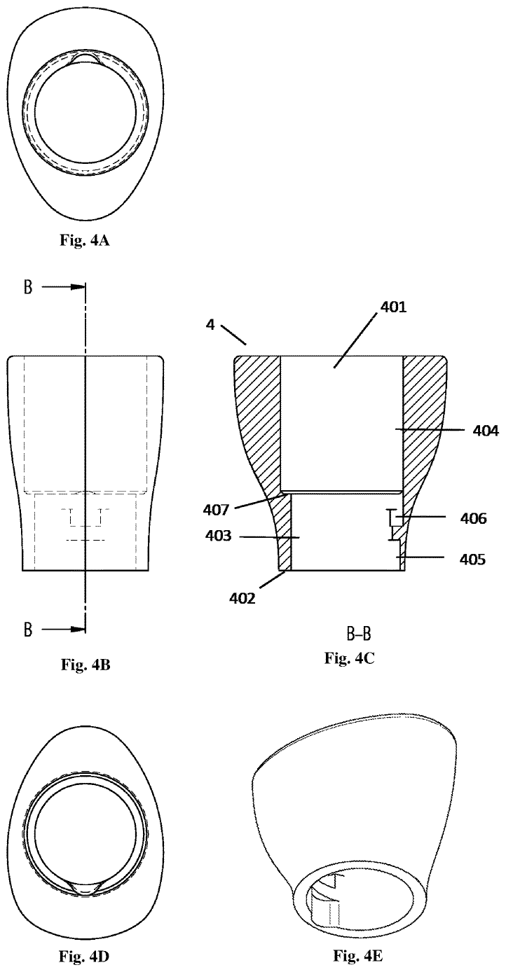

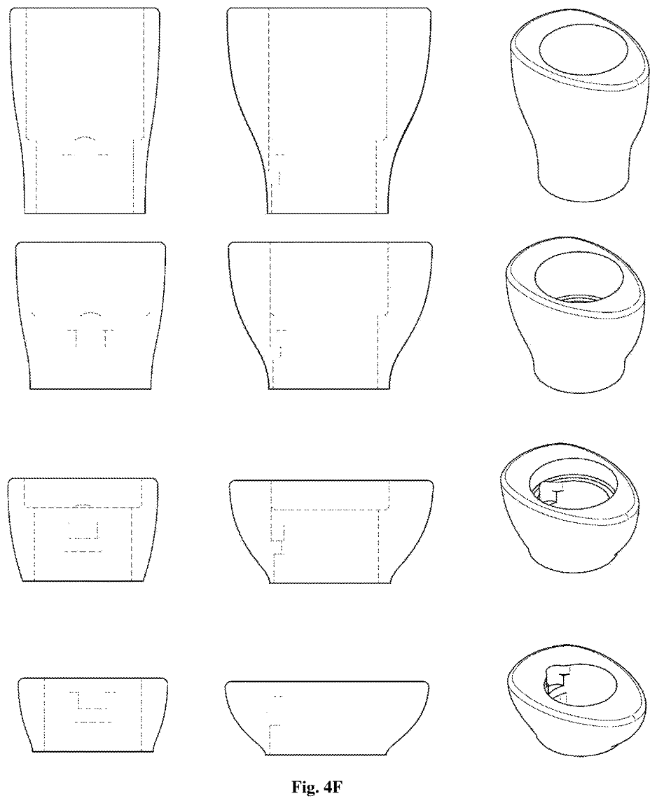

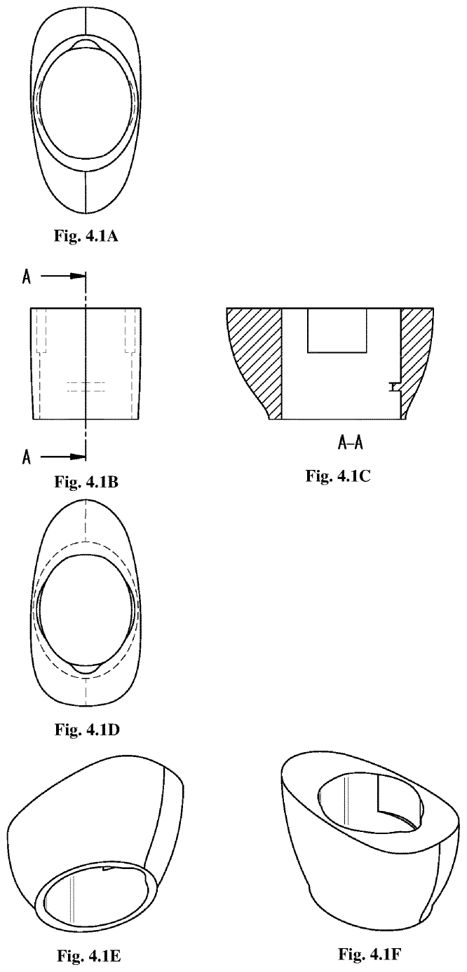

FIGS. 4A to 4E show a first embodiment of the gingival extension 4 according to the invention, which comprises a body with a through cavity 401 of a circular shape extending in the coronal-apical direction. An annular apical abutment surface 402 directed apically is arranged on the outer surface of the gingival extension 4 at the apical end. The through cavity 401 comprises an apical section 403 comprising, at its apical end, along a part of its circumference, an apical anti-rotation recess 405 directed radially outwards and, at its coronal end, along part of its circumference, a coronal anti-rotation recess 406 directed radially outwards. The through cavity 401 in this embodiment further includes a coronal section 404 which is coaxial with the apical section 403 and which is wider than the apical section 403 in cross-section along the entire circumference. A coronal abutment surface 407 directed coronally is formed at the transition between the inner surface of the apical section 403 of the through cavity 401 and the inner surface of the coronal section 404 of the through cavity 401.

FIG. 4F shows other embodiments of the first embodiment of the gingival extension according to the invention with different heights. It is apparent that the lowest embodiment shown at the bottom does not comprise the coronal section 404, and thus, in this embodiment, the coronal abutment surface 407 is formed at the transition between the inner surface of the apical section 403 of the through cavity 401 and the outer surface of the coronal end of the gingival extension 4, i.e. on the outer surface of the coronal end of the gingival extension 4 in the immediate vicinity of the coronal end of the through cavity 401.

FIG. 4.1A to 4.1F show the second embodiment of the gingival extension 4 according to the invention, which differs from the above mentioned first embodiment according to FIGS. 4A to 4E in particular in that the through cavity 401 has an oval shape in cross-section and its coronal section 404 is wider in cross-section than the apical section 403 only along a part of its circumference, namely its oval cross-section is widened on two opposite sides of the shorter axis of symmetry in order to accommodate the circular head of the healing body plug and the corresponding parts of the other components of the assembly according to the invention. Coronal abutment surface 407 is thus also formed only along a part of the inner circumference of the through cavity 401.

### Healing Body Plug

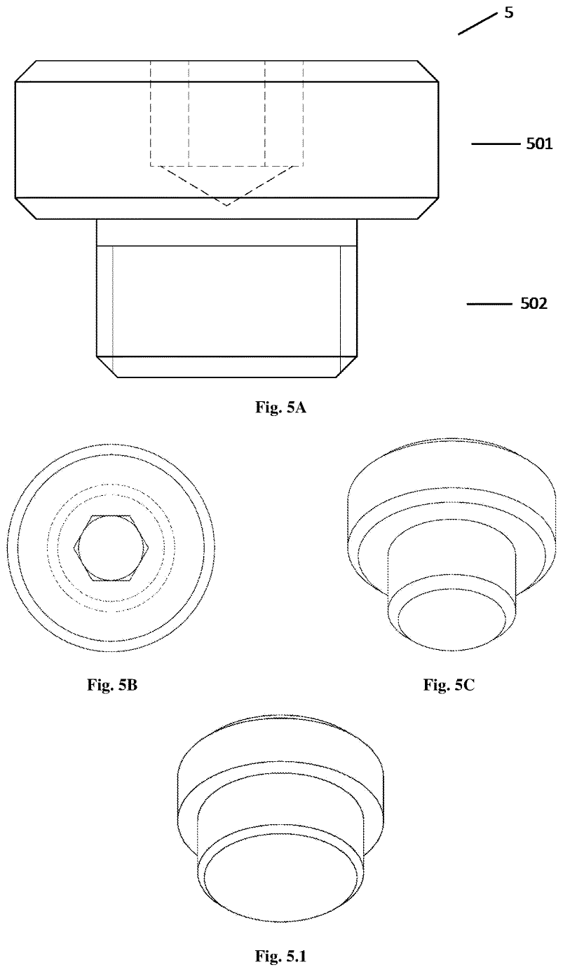

FIGS. 5A to 5C show a first embodiment of the healing body plug 5, which has the shape of a screw with a head 501 and a shank 502 provided with an external thread.

FIG. 5.1 shows a second embodiment of the healing body plug 5 according to the invention, which is formed in a similar way to the above mentioned first embodiment from FIGS. 5A to 5C.

### Healing Body Assembly

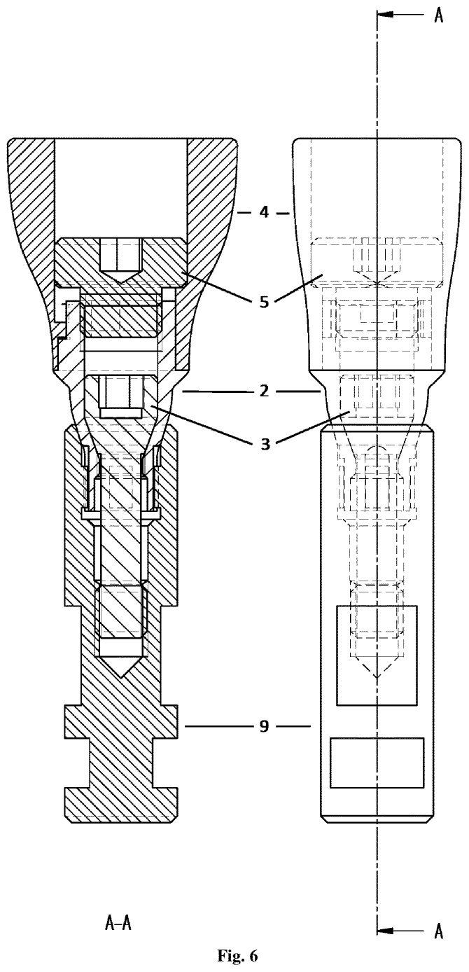

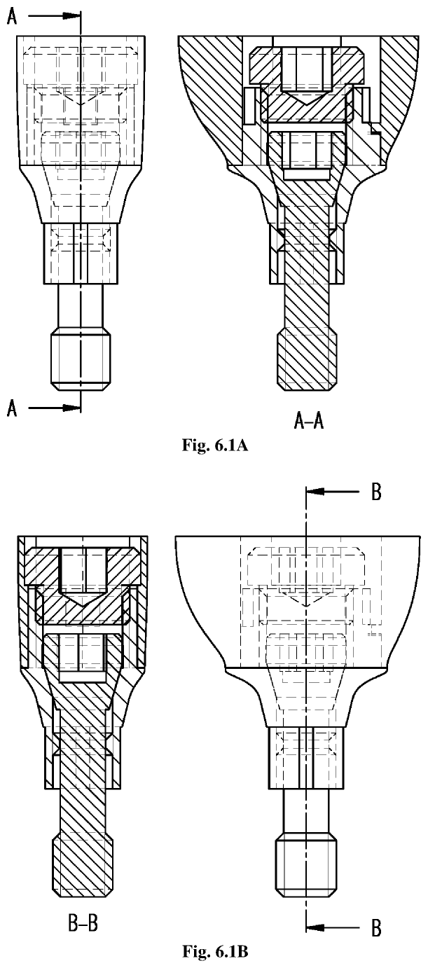

FIG. 6 shows a first embodiment of the healing body assembly according to the invention comprising
the above mentioned first embodiment of the base 2 of the healing body according to FIGS. 2A to 2E;
the above mentioned first embodiment of the gingival extension 4 according to FIGS. 4A to 4E,
wherein the apical section 403 of the through cavity 401 of the gingival extension 4 is put on the coronal portion 205 of the base 2 from outside so that the apical abutment surface 402 of the gingival extension 4 abuts against the axial abutment surface 203 of the base 2, the anti-rotation projection 208 of the base 2 fits into the apical anti-rotation recess 405 of the gingival extension 4 and the through cavities 401, 201 of the gingival extension 4 and the base 2 are coaxially connected to form a common through cavity of the healing body assembly;
the above mentioned first embodiment of the basal screw 3 according to FIGS. 3A and 3B, which is inserted into the common through cavity of the healing body assembly and screwed through the apical internal thread 211 of the through cavity 201 of the base 2 for fixing the healing body assembly in an implant analog 9 by means of the external thread 304 at the apical end of the shank 302 of the basal screw 3 so that the bearing surface 303 of the head 301 of the basal screw 3 rests on the transition section 206 of the through cavity 201 of the base 2, and the head 301 of the basal screw 3 does not interfere into the space of the coronal internal thread 209 at the coronal end of the coronal portion 205 of the through cavity 201 of the base 2; and
the above mentioned first embodiment of the healing body plug 5 according to FIGS. 5A to 5C, which is inserted into the common through cavity of the healing body assembly for fixing the gingival extension 4 in the base 2 so that the external thread at the apical end of the shank 502 of the plug 5 is screwed into the coronal internal thread 209 of the base 2 so that the head 501 of the plug 5 rests on the coronal abutment surface 407 of the gingival extension 4.

FIG. 6.1A and 6.1B show a second embodiment of the healing body assembly according to the invention comprising
the above mentioned second embodiment of the base 2 of the healing body according to FIG. 2.1A to 2.1F;
the above mentioned second embodiment of the gingival extension 4 according to FIG. 4.1A to 4.1F, put on the base 2 in a similar way to the above mentioned first embodiment according to FIG. 6;
a second embodiment of the basal screw 3 similar to the above mentioned first embodiment according to FIGS. 3A and 3B, which is intended for fixing the healing body assembly in an implant in a similar way to the above mentioned first embodiment according to FIG. 6; and
the above mentioned second embodiment of the healing body plug 5 according to FIG. 5.1, which is inserted into the common through cavity of the healing body assembly for fixing the gingival extension 4 in the base 2 so that the external thread at the apical end of the shank 502 of the plug 5 is screwed into the coronal internal thread 209 of the base 2 so that the head 501 of the plug 5 rests on the coronal abutment surface 407 of the gingival extension 4.

### Impression Pin

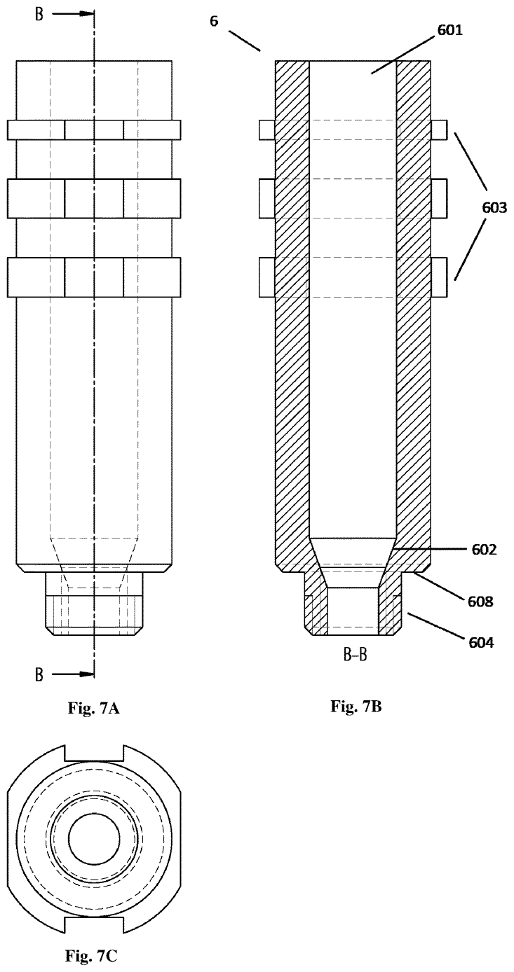

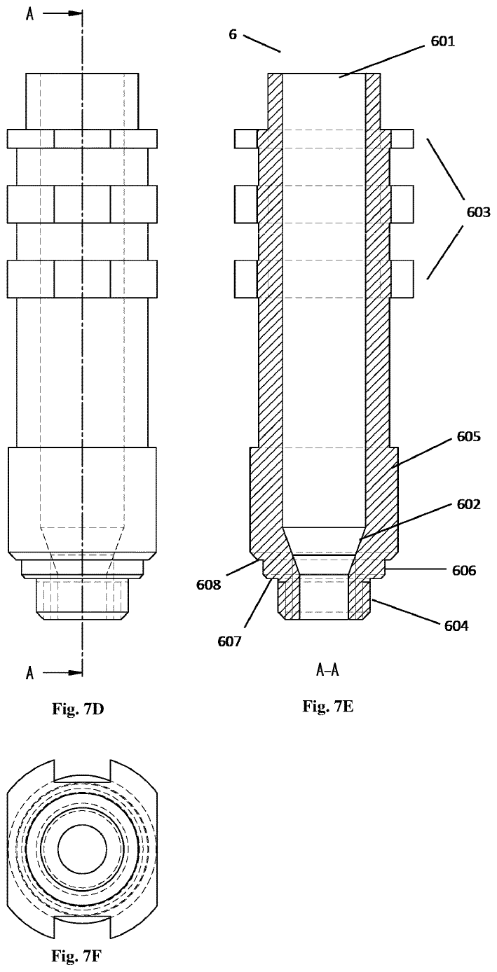

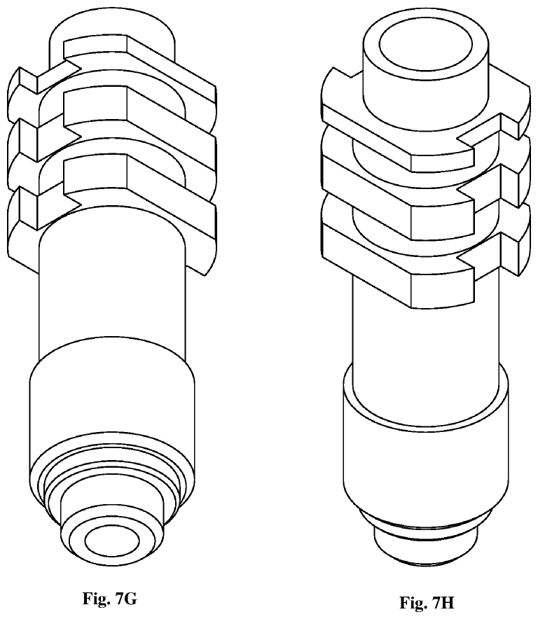

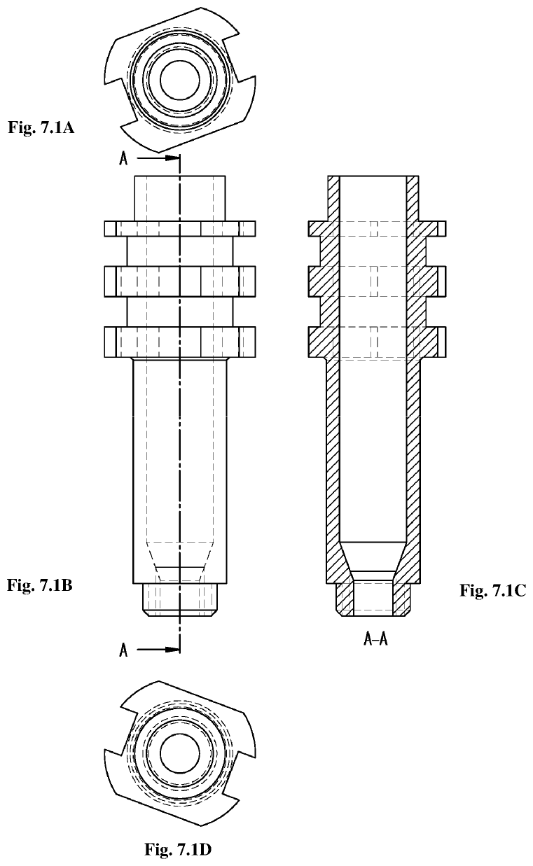

FIGS. 7A to 7C show a first embodiment of the impression pin 6 according to the invention, which has the shape of a hollow cylindrical body with a through cavity 601 extending in the coronal-apical direction and having a larger cross-sectional diameter at the coronal end than at the apical end, wherein the inner surface of the through cavity 601 transitions from the cross-sectional diameter at the coronal end to the cross-sectional diameter at the apical end by a transition section 602, wherein fixing means 603 for fixing the impression material are arranged on the outer surface of the cylindrical body at the coronal end, and a threaded section 604 having an external thread and a smaller external diameter than the cylindrical body is formed at the apical end, while at the transition of the outer surface between the threaded section 604 and the cylindrical body, a coronal bearing surface 608 directed apically is formed.

FIGS. 7D to 7H show a preferable variant of the first embodiment of the impression pin 6 according to the invention, in which the cylindrical body does not have the same external diameter throughout the entire extension and it is narrower in the section starting at a distance from the threaded section 604 and extending in the coronal direction so that an widened section 605 having a larger external diameter than the cylindrical body of the impression pin is formed coronally from the threaded section 604 at the apical end of the impression pin 6. Furthermore, an intermediate section 606 having a smaller external diameter than the widened section 605 and a larger external diameter than the threaded section 604 is arranged at the apical end of the impression pin 6 between the widened section 605 and the threaded section 604, so that the coronal abutment surface 608 is formed at the transition of the outer surface between the intermediate section 606 and the widened section 605 and an apical bearing surface 607 directed apically is formed at the transition of the outer surface between the intermediate section 606 and the threaded section 604.

FIG. 7.1A to 7.1D show a second embodiment of the imprinting pin 6 according to the invention, which is formed in a similar way to the above mentioned first embodiment from FIGS. 7A to 7C.

### Impression Pin Assembly

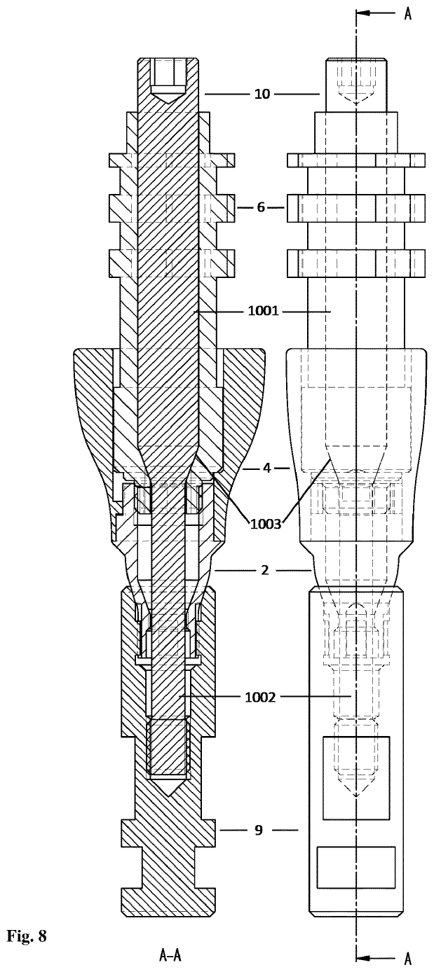

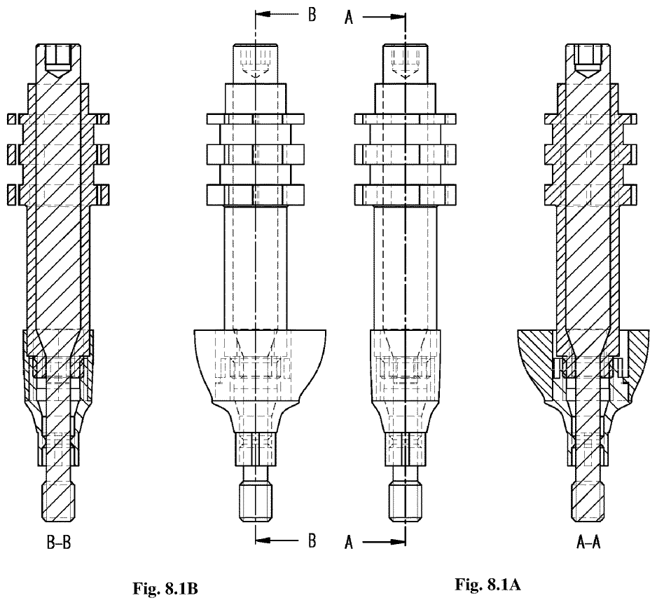

FIG. 8 shows a first embodiment of an impression pin assembly according to the invention comprising
the above mentioned first embodiment of the base 2 of the healing body according to FIGS. 2A to 2E;
the above mentioned first embodiment of the gingival extension 4 according to FIGS. 4A to 4E, put on the base 2 in a similar way to the above mentioned first embodiment of the healing body assembly according to FIG. 6;
the above mentioned preferable variant of the first embodiment of the impression pin 6 according to FIGS. 7D to 7H, wherein the apical end of the impression pin 6 is inserted into the common through cavity of the healing body assembly so that the threaded section 604 of the impression pin 6 is screwed into the coronal internal thread 209 of the base 2, the coronal abutment surface 608 of the impression pin 6 abuts against the coronal abutment surface 407 of the gingival extension 4, the apical bearing surface 607 of the impression pin 6 faces against the coronal abutment surface 210 of the base 2 and the through cavities 601, 401, 201 of the impression pin 6, the gingival extension 4 and the base 2 are coaxially connected to form a common through cavity of the impression pin assembly;
an impression pin screw 10, which is inserted into the common through cavity of the impression pin assembly and screwed through the apical internal thread 211 of the through cavity 201 of the base 2 for fixing the impression pin assembly in an implant analog 9 by means of the external thread at the apical end of the shank 1002 of the impression pin screw 10 so that the bearing surface 1003 of the head 1001 of the impression pin screw 10 rests on the transition section 602 of the through cavity 601 of the impression pin 6.

FIG. 8.1A and 8.1B show a second embodiment of an impression pin assembly according to the invention, comprising
the above mentioned second embodiment of the healing body base 2 according to FIG. 2.1A to 2.1F;
the above mentioned second embodiment of the gingival extension 4 according to FIG. 4.1A to 4.1F, put on the base 2 in a similar way to the above mentioned first embodiment of the healing body assembly according to FIG. 6;
the above mentioned second embodiment of the impression pin 6 according to FIG. 7.1A to 7.1D, wherein the apical end of the impression pin 6 is inserted into the common through cavity of the healing body assembly so that the threaded portion 604 of the impression pin 6 is screwed into the coronal internal thread 209 of the base 2, the coronal abutment surface 608 of the impression pin 6 abuts against the coronal abutment surface 407 of the gingival extension 4 and the through cavities 601, 401, 201 of the impression pin 6, the gingival extension 4 and the base 2 are coaxially connected to form a common through cavity of the impression pin assembly;
an impression pin screw 10, which is intended for fixing the impression pin assembly in the implant in a similar way to the above mentioned first embodiment according to FIG. 8.

### Control Pin

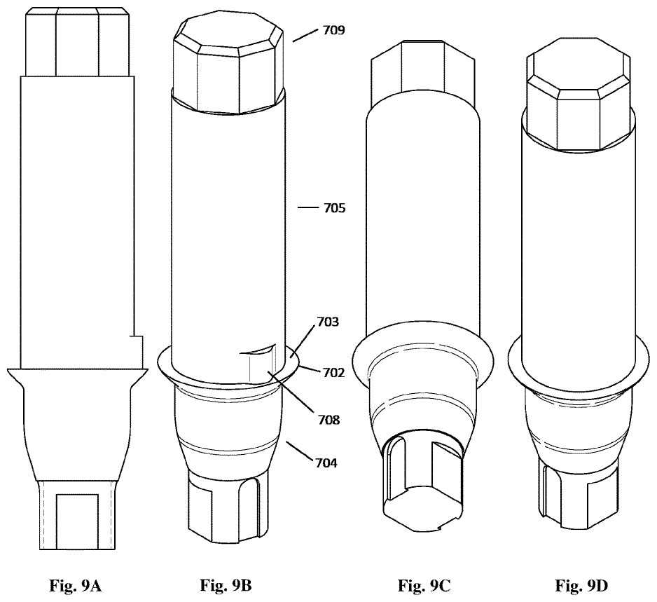

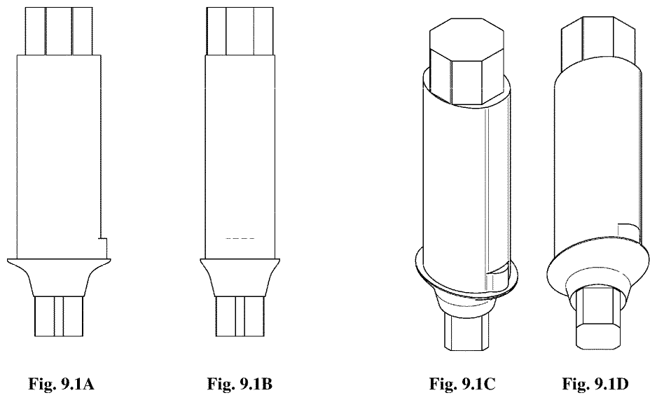

FIGS. 9A to 9D show a first embodiment of the control pin 7 according to the invention, comprising an annulus 702 on the outer surface with an annular axial abutment surface 703 directed coronally, which has a circumference in the shape of a circle and which divides the control pin Z into an apical portion 704 for attachment to the implant and a coronal portion 705, which has a cylindrical shape with a circular cross-section, an anti-rotation projection 708 directed radially outwards is arranged on the outer circumference at its apical end, and an octagonal control element 709 is arranged at its coronal end.

FIG. 9.1A to 9.1D show a second embodiment of the control pin Z according to the invention, differing from the above mentioned first embodiment according to FIGS. 9A to 9D in particular in that the annular axial abutment surface 703 and the coronal portion 705 are oval.

### Control Pin Assembly

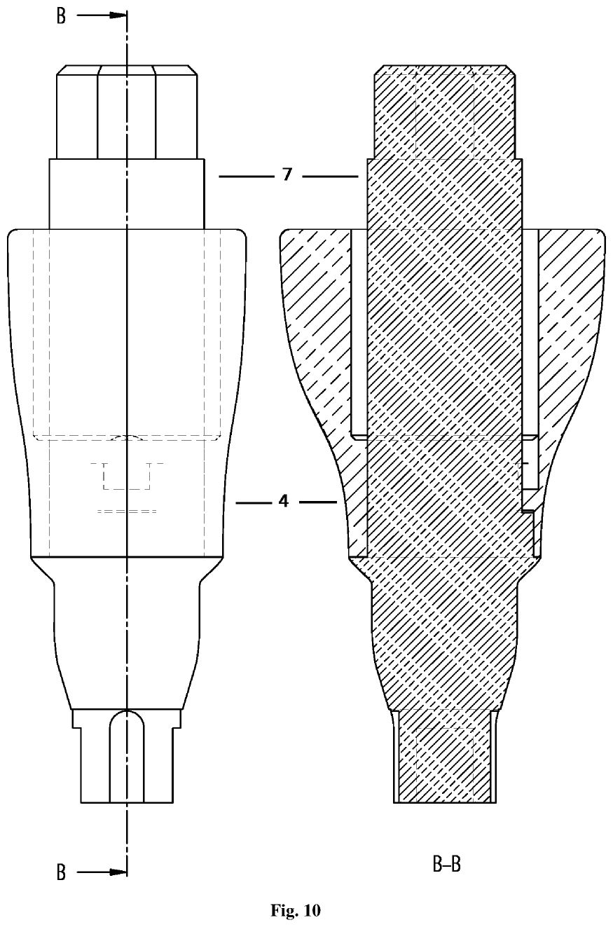

FIG. 10 shows a first embodiment of the control pin assembly according to the invention, comprising
the above mentioned first embodiment of the control pin Z according to FIGS. 9A to 9D; and
the above mentioned first embodiment of the gingival extension 4 according to FIGS. 4A to 4E,
   wherein the apical section 403 of the through cavity 401 of the gingival extension 4 is put on the coronal portion 705 of the control pin Z from outside so that the apical abutment surface 402 of the gingival extension 4 abuts against the axial abutment surface 703 of the control pin Z and the anti-rotation projection 708 of the control pin Z fits into the apical anti-rotation recess 405 of the gingival extension 4.

A second embodiment of the control pin assembly according to the invention, comprising
the above mentioned second embodiment of the control pin Z according to FIG. 9.1A to 9.1D; and
the above mentioned second embodiment of the gingival extension 4 according to FIG. 4.1A to 4.1F, put on the control pin 7 in a similar way to the above mentioned first embodiment according to FIG. 10,
   is not shown in the drawings.

### Scanning Body

FIGS. 11A to 11G show a first embodiment of the scanning body & according to the invention, comprising a body 802 and a head 803, which is arranged at the coronal end of the body 802 so that the body 802 and the head 803 together have the shape of a hollow cylindrical body having circular cross-section with a through cavity 801 extending in the coronal-apical direction, on the inner surface of which an inner bearing surface 804 is formed, whereas a scanning recess 806 is formed on the outer surface at the coronal end of the head 803, and an anti-rotation projection 809 directed radially outwards and an apical abutment surface 810 directed apically, from which three identification protrusions 808 protrude in the apical direction, are arranged at the apical end of the body 802. The anti-rotation projection 809 extends beyond the apical abutment surface 810 in the apical direction by a shorter distance than the identification protrusions 808. The through cavity 801 of the scanning body 8 is provided apically from the inner bearing surface 804 with a preferable internal thread 805 for screwing through the scanning body screw 11.

FIGS. 11H to 11O show a preferred variant of the first embodiment of the scanning body 8 according to the invention, which is formed in a similar way to the above mentioned first embodiment according to FIGS. 11A to 11G and differs in that the inner bearing surface 804 is formed in such a way that the through cavity 801 is narrowed apically from the inner bearing surface 804 and an internal bearing surface 804 is formed at the transition of the inner surface of the through cavity 801 between the narrower and wider section, and in that the cylinder of the body 802 has a larger external cross-sectional diameter than the apical end of the body 802 apically from the head 803 in the coronal part along the entire outer circumference, so that an apical narrowed section 807 is formed at the apical end of the body 802 and the coronal abutment surface 811 is formed at the transition of the outer surface between the apical narrowed section 807 and the rest of the body 802, interrupted by an anti-rotation projection 809 reaching in the radial direction to the level of the outer surface of the body 802 with the larger external diameter.

FIG. 11P shows three exemplary distributions of the identification protrusions and the anti-rotation projection for the first embodiment of the scanning body according to the invention.

FIG. 11.1A to 11.1G show a second embodiment of the scanning body 8 according to the invention, which is formed in a similar way to the above mentioned first embodiment according to FIGS. 11A to 11G and differs in particular in that it has the shape of a hollow cylindrical body with an oval cross-section, two identification protrusions 808 protrude in the apical direction at the apical end of the body 802 from the apical abutment surface 810 directed apically, one of which is joined into one unit with the anti-rotation projection 809 and the anti-rotation projection 809 extends beyond the apical abutment surface 810 in the apical direction by the same distance as the identification protrusions 808.

FIG. 11.1H shows three exemplary distributions of the identification protrusions and the anti-rotation projection for the second embodiment of the scanning body according to the invention.

### Scanning Body Assembly

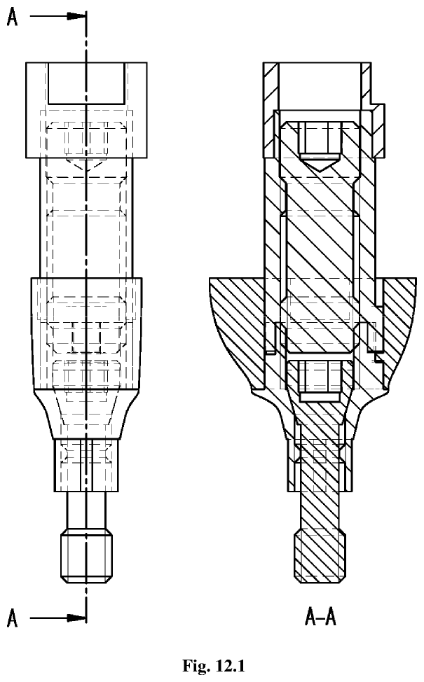

FIG. 12 shows a first embodiment of the scanning body assembly according to the invention, comprising
the above mentioned first embodiment of the base 2 of the healing body according to FIGS. 2A to 2E;
the above mentioned first embodiment of the gingival extension 4 according to FIGS. 4A to 4E, put on the base 2 in a similar way to the above mentioned first embodiment of the healing body assembly according to FIG. 6;
the above mentioned first embodiment of the basal screw 3 according to FIGS. 3A and 3B, which is screwed into the implant analog 9 for fixing the base 2 and the gingival extension 4, in a similar way to the above mentioned first embodiment of the healing body assembly according to FIG. 6; and
the above mentioned preferable embodiment of the first embodiment of the scanning body 8 according to FIGS. 11H to 11O, wherein the apical end of the scanning body 8 is inserted into the common through cavity of the healing body assembly so that the anti-rotation projection 809 fits into the coronal anti-rotation recess 406 of the gingival extension 4, the apical abutment surface 810 abuts against the coronal abutment surface 210 of the base 2, the coronal abutment surface 811 faces against the coronal abutment surface 407 of the gingival extension 4, the identification protrusions 808 fit into the identification reliefs 207 of the base 2, and the through cavities 801, 401, 201 of the scanning body 8, the gingival extension 4 and the base 2 are coaxially connected to form a common through cavity of the scanning body assembly; and
a scanning body screw 11, which is inserted into the common through cavity of the scanning body assembly and screwed through the internal thread 805 of the through cavity 801 of the scanning body 8 for fixing the scanning body 8 and the gingival extension 4 in the base 2 so that the external thread at the apical end of the shank 1102 of the scanning body screw 11 is screwed into the coronal internal thread 209 of the base 2 so that the bearing surface 1103 of the head 1101 of the scanning body screw 11 rests on the internal bearing surface 804 of the scanning body 8.

FIG. 12.1 shows a second embodiment of the scanning body assembly according to the invention, comprising
the above mentioned second embodiment of the base 2 of the healing body according to FIG. 2.1A to 2.1F;
the above mentioned second embodiment of the gingival extension 4 according to FIG. 4.1A to 4.1F, put on the base 2 in a similar way to the above mentioned first embodiment of the healing body assembly according to FIG. 6;
a second embodiment of the basal screw 3 similar to the above mentioned first embodiment according to FIGS. 3A and 3B, which is intended for fixing the base 2 and the gingival extension 4 in the implant in a similar way to the above mentioned first embodiment of the healing body assembly according to FIG. 6; and
the above mentioned second embodiment of the scanning body 8 according to FIG. 11.1A to 11.1G, wherein the apical end of the scanning body 8 is inserted into the common through cavity of the healing body assembly so that the anti-rotation projection 809 fits into the coronal anti-rotation recess 406 of the gingival extension 4, the apical abutment surface 810 abuts against the coronal abutment surface 210 of the base 2, the identification protrusions 808 fit into the identification reliefs 207 of the base 2 and the through cavities 801, 401, 201 of the scanning body 8, the gingival extension 4 and the base 2 are coaxially connected and form a common through cavity of the scanning body assembly; and
a scanning body screw 11, which is screwed for fixing the scanning body 8 and the gingival extension 4 in the base 2 in a similar way to the above mentioned first embodiment according to FIG. 12.

### Kit

The exemplary kit is intended for one type of implant in two sizes (model for Straumann Bonelevel implants, size NC and RC) and comprises:
1. implant plug (3 heights for each implant):
   NC1=10 pcs, NC2=10 pcs, NC3=10 pcs
   RC1=20 pcs, RC2=20 pcs, RC3=10 pcs
2. base (two basic heights for each implant—1 and 2 mm):
   NC1=30 pcs, NC2=30 pcs
   RC1=50 pcs, RC2=50 pcs
3. basal screw (common for both implants): 180 pcs
4. healing body plug (common for both implants): 180 pcs
5. gingival extension (6 types according to position in the jaw, each in 4 heights—2.5, 3.5, 5 and 7 mm, i.e. 24 types): 180 to 200 pcs in total
6. impression pin (common for both implants): 40 pcs
7. impression pin screw (common for both implants): 40 pcs
8. scanning body (different for each type of base, i.e. 4 types):
   NC1=15 pcs., NC2=15 pcs
   RC1=20 pcs, RC2=20 pcs
9. scanning body screw (the same for all of them): 70 pcs
10. control pin (one type for each implant size): NC=5 pcs. ; RC=5 pcs

### LIST OF REFERENCE NUMERALS

1 implant plug
101 head
102 shank
103 external thread
2 base
201 through cavity
202 annulus
203
204 apical portion
205 coronal portion
206 transition section
207 identification relief
208 anti-rotation projection
209 coronal internal thread
210 coronal abutment surface
211 apical internal thread
3 basal screw
301 head
302 shank
303 bearing surface
304 external thread
4 gingival extension
401 through cavity
402 apical abutment surface
403 apical section of the through cavity
404 coronal section of the through cavity
405 apical anti-rotation recess
406 coronal anti-rotation recess
407 coronal abutment surface
5 healing body plug
501 head
502 shank
6 impression pin
601 through cavity
602 transition section
603 fixing means
604 threaded section
605 widened section
606 intermediate section
607 apical bearing surface
608 coronal abutment surface
702 annulus
703 axial abutment surface
704 apical portion
705 coronal portion
708 anti-rotation projection
709 control element
8 scanning body
801 through cavity
802 body
803 head
804 inner bearing surface
805 internal thread
806 scanning recess
807 apical narrowed section
808 identification protrusion
809 anti-rotation projection
810 apical abutment surface
811 coronal abutment surface
9 implant analog
10 impression pin screw
1001 head
1002 shank
1003 bearing surface
11 scanning body screw
1101 head
1102 shank
1103 bearing surface

1-10. (canceled)

11. A healing body system comprising:
a gingival extension (4) configured for shaping soft tissue above an implant, the gingival extension (4) comprising a body with a through cavity (401) extending in a coronal-apical direction, the body having an external shape of which imitates, at least in a part to be in contact with the soft tissue, a shape of a transition neck of a dental crown,
wherein an annular apical abutment surface (402) directed apically is arranged at an apical end on an outer surface of the gingival extension (4);
wherein the through cavity (401) of the gingival extension (4) comprises:
an apical section (403) having an apical end and a coronal end and comprising, at the apical end, along a part of a circumference, an apical anti-rotation recess (405) directed radially outwards, and at the coronal end, along a part of the circumference, a coronal anti-rotation recess (406) directed radially outwards;
optionally a coronal section (404) which is coaxial with the apical section (403) and which is wider than the apical section (403) in cross-section at least along a part of its circumference;
a coronal abutment surface (407) directed coronally and being formed at a transition between an inner surface of the apical section (403) of the through cavity (401) of the gingival extension (4) and an outer surface of the coronal end of the gingival extension (4), or the inner surface of the coronal section (404) of the through cavity (401) of the gingival extension (4); and
a base (2) configured for attachment to an implant, the base (2) comprising a body with a through cavity (201) extending in the coronal-apical direction and having an annulus (202) on an outer surface with an annular axial abutment surface (203) directed coronally, which divides the base (2) into an apical portion (204) configured for attachment to the implant and a coronal portion (205),
wherein the through cavity (201) has a larger cross-sectional diameter at a coronal end than at an apical end, and an inner surface of the through cavity (201) transitions in an apical portion (204) of the base (2) from a cross-sectional diameter at the coronal end to a cross-sectional diameter at the apical end by a transition section (206),
wherein the coronal portion (205) has a tubular shape and has a plane coronal abutment surface (210) at the coronal end;
wherein at least one identification relief (207) directed radially inwards is arranged on an outer circumference of the coronal end of the coronal portion (205);
wherein an anti-rotation projection (208) directed radially outwards is formed on an outer circumference of the apical end of the coronal portion (205) for fitting into the apical anti-rotation recess (405) of the gingival extension (4); and
wherein the through cavity (201) of the base is provided with a coronal internal thread (209) at the coronal end of the coronal portion (205).

12. A healing body subassembly, comprising the healing body system according to claim 11,
wherein the apical section (403) of the through cavity (401) of the gingival extension (4) is put on the coronal portion (205) of the base (2) from outside so that the apical abutment surface (402) of the gingival extension (4) abuts against the axial abutment surface (203) of the base (2), the anti-rotation projection (208) of the base (2) fits into the apical anti-rotation recess (405) of the gingival extension (4), and the through cavities (401, 201) of the gingival extension (4) and the base (2) are coaxially connected to form a common through cavity of the healing body subassembly.

13. A healing body assembly, comprising:
the healing body subassembly according to claim 12;
a basal screw (3) which is inserted into the common through cavity of the healing body subassembly for fixing the healing body subassembly in an implant by means of an external thread (304) at an apical end of a shank (302) of the basal screw (3) so that a bearing surface (303) of a head (301) of the basal screw (3) rests on a transition section (206) of the through cavity (201) of the base (2) and the head (301) of the basal screw (3) does not interfere into a space of the coronal internal thread (209) at the coronal end of the coronal portion (205) of the through cavity (201) of the base (2); and
a healing body plug (5), which is inserted into the common through cavity of the healing body subassembly for fixing the gingival extension (4) in the base (2) so that the external thread at the apical end of the shank (502) of the plug (5) is screwed into the coronal internal thread (209) of the base (2) so that a head (501) of the plug (5) rests on the coronal abutment surface (407) of the gingival extension (4).

14. The healing body system according to claim 11, further comprising:
an impression pin (6) which has the shape of a hollow cylindrical body with a through cavity (601) extending in the coronal-apical direction and having a larger cross-sectional diameter at a coronal end than at an apical end, wherein an inner surface of the through cavity (601) transitions from the cross-sectional diameter at the coronal end to the cross-sectional diameter at the apical end by a transition section (602), wherein fixing means (603) configured for fixing impression material are arranged on an outer surface of the cylindrical body at the coronal end, and a threaded section (604) having an external thread and a smaller external diameter than the cylindrical body is formed at the apical end, while at a transition of the outer surface between the threaded section (604) and the cylindrical body, a coronal abutment surface (608) directed apically is formed.

15. An impression pin assembly comprising:
the healing body subassembly according to claim 12 and an impression pin (6) which has the shape of a hollow cylindrical body with a through cavity (601) extending in the coronal-apical direction and having a larger cross-sectional diameter at a coronal end than at an apical end, wherein an inner surface of the through cavity (601) transitions from the cross-sectional diameter at the coronal end to the cross-sectional diameter at the apical end by a transition section (602), wherein fixing means (603) configured for fixing impression material are arranged on an outer surface of the cylindrical body at the coronal end, and a threaded section (604) having an external thread and a smaller external diameter than the cylindrical body is formed at the apical end, while at a transition of the outer surface between the threaded section (604) and the cylindrical body, a coronal abutment surface (608) directed apically is formed, wherein the apical end of the impression pin (6) is inserted into the common through cavity of the healing body subassembly so that the threaded section (604) of the impression pin (6) is screwed into the coronal internal thread (209) of the base (2), the coronal abutment surface (608) of the impression pin (6) abuts against the coronal abutment surface (407) of the gingival extension (4) and the through cavities (601, 401, 201) of the impression pin (6), the gingival extension (4) and the base (2) are coaxially connected to form a common through cavity of the impression pin assembly; and
an impression pin screw (10), which is inserted into the common through cavity of the impression pin assembly for fixing the impression pin assembly in the implant by means of an external thread at the apical end of a shank (1002) of the impression pin screw (10) so that a bearing surface (1003) of a head (1001) of the impression pin screw (10) rests on the transition section (602) of the through cavity (601) of the impression pin (6).

16. The healing body system according to claim 11, further comprising:
a scanning body (8) which comprises a body (802) and a head (803) arranged at the coronal end of the body (802) so that the body (802) and the head (803) together have a shape of a hollow cylindrical body with a through cavity (801) extending in the coronal-apical direction, on an inner surface of which an inner bearing surface (804) is formed, whereas a scanning recess (806) is formed on an outer surface at the coronal end of the head (803), and an anti-rotation projection (809) directed radially outwards and an apical abutment surface (810) directed apically, from which at least one identification protrusion (808) protrudes in the apical direction, are arranged at an apical end of the body (802).

17. A scanning body assembly, comprising:
the healing body subassembly according to claim 12;
a basal screw (3) which is inserted into the common through cavity of the healing body subassembly for fixing the healing body subassembly in an implant by means of an external thread (304) at the apical end of the shank (302) of the basal screw (3) so that the bearing surface (303) of the head (301) of the basal screw (3) rests on the transition section (206) of the through cavity (201) of the base (2) and the head (301) of the basal screw (3) does not interfere into the space of the coronal internal thread (209) at the coronal end of the coronal portion (205) of the through cavity (201) of the base (2);
a scanning body (8) which comprises a body (802) and a head (803) arranged at the coronal end of the body (802) so that the body (802) and the head (803) together have a shape of a hollow cylindrical body with a through cavity (801) extending in the coronal-apical direction, on an inner surface of which an inner bearing surface (804) is formed, whereas a scanning recess (806) is formed on an outer surface at the coronal end of the head (803), and an anti-rotation projection (809) directed radially outwards and an apical abutment surface (810) directed apically, from which at least one identification protrusion (808) protrudes in the apical direction, are arranged at an apical end of the body (802),
wherein the apical end of the scanning body (8) is inserted into the common through cavity of the healing body subassembly so that the anti-rotation projection (809) fits into the coronal anti-rotation recess (406) of the gingival extension (4), the apical abutment surface (810) abuts against the coronal abutment surface (210) of the base

(2) said at least one identification protrusion (808) fits into said at least one identification relief (207) of the base (2) and the through cavities (801, 401, 201) of the scanning body (8), the gingival extension (4) and the base (2) are coaxially connected to form a common through cavity of the scanning body assembly; and
a scanning body screw (11), which is inserted into the common through cavity of the scanning body assembly for fixing the scanning body (8) and the gingival extension (4) in the base (2) so that the external thread at the apical end of the shank (1102) of the scanning body screw (11) is screwed into the coronal internal thread (209) of the base (2) so that the bearing surface (1103) of the head (1101) of the scanning body screw (11) rests on the inner bearing surface (804) of the scanning body (8).

18. A kit comprising:
the healing body system according to claim 11, and
at least one of the following components:
an impression pin (6) which has the shape of a hollow cylindrical body with a through cavity (601) extending in the coronal-apical direction and having a larger cross-sectional diameter at a coronal end than at an apical end, wherein an inner surface of the through cavity (601) transitions from the cross-sectional diameter at the coronal end to the cross-sectional diameter at the apical end by a transition section (602), wherein fixing means (603) configured for fixing impression material are arranged on an outer surface of the cylindrical body at the coronal end, and a threaded section (604) having an external thread and a smaller external diameter than the cylindrical body is formed at the apical end, while at a transition of the outer surface between the threaded section (604) and the cylindrical body, a coronal abutment surface (608) directed apically is formed.
a scanning body (8) which comprises a body (802) and a head (803) arranged at the coronal end of the body (802) so that the body (802) and the head (803) together have a shape of a hollow cylindrical body with a through cavity (801) extending in the coronal-apical direction, on an inner surface of which an inner bearing surface (804) is formed, whereas a scanning recess (806) is formed on an outer surface at the coronal end of the head (803), and an anti-rotation projection (809) directed radially outwards and an apical abutment surface (810) directed apically, from which at least one identification protrusion (808) protrudes in the apical direction, are arranged at an apical end of the body (802),
a control pin (7) configured for controlling a position of the implant, comprising an annulus (702) on an outer surface with an annular axial abutment surface (703) directed coronally, which divides the control pin (7) into an apical portion (704) for attachment to the implant and a coronal portion (705), which has a cylindrical shape, an anti-rotation projection (708) directed radially outwards arranged on the outer circumference at its apical end for fitting into the apical anti-rotation recess (405) of the gingival extension (4), and a control element (709) is arranged at its coronal end;
an implant plug (1) configured for shaping bone tissue around the implant, the implant plug (1) having a shape of a screw with a head (101) and a shank (102), which has an external thread (103) at an apical end for attachment to the implant;
a basal screw (3) having a shank (302) provided with an external thread (304) at an apical end for fixing the gingival extension (4) and the base (2) in the implant after insertion into a common through cavity formed by the through cavities (401, 201) of the gingival extension (4) and the base (2), and a head (301) with a bearing surface (303) for resting on the transition section (206) of the through cavity (201) of the base (2), wherein the head (301) of the basal screw (3) does not interfere into the space of the coronal internal thread (209) at the coronal end of the coronal portion (205) of the through cavity (201) of the base (2);
a healing body plug (5) having a shank (502) provided with an external thread at an apical end for screwing into the coronal internal thread (209) of the base (2) after insertion into the common through cavity formed by the through cavities (401, 201) of the assembly of the gingival extension (4) and the base (2) for fixing the gingival extension (4) in the base (2), and a head (501) for resting on the coronal abutment surface (407) of the gingival extension (4);
an impression pin screw (10) having a shank (1002) provided with an external thread at an apical end for fixing the assembly of the impression pin (6), the gingival extension (4) and the base (2) in the implant after insertion into the common through cavity formed by the through cavities (601, 401, 201) of the impression pin (6), the gingival extension (4) and the base (2), and a head (1001) with a bearing surface (1003) for resting on the transition section (602) of the through cavity (601) of the impression pin (6); and
a scanning body screw (11) having a shank (1102) provided with an external thread at an apical end for screwing into the coronal internal thread (209) of the base (2) after insertion into the common through cavity formed by the through cavities (801, 401, 201) of the scanning body (8), the gingival extension (4) and the base (2) for fixing the scanning body (8) and the gingival extension (4) in the base (2), and a head (1101) with a bearing surface (1103) for resting on the inner bearing surface (804) of the scanning body (8).
